(19) United States
(12) Patent Application Publication
(10) Pub. No.: US 2012/0131316 A1
(43) Pub. Date: May 24, 2012

(54) METHOD AND APPARATUS FOR IMPROVED SECURE COMPUTING AND COMMUNICATIONS

(76) Inventors: Joseph Mitola, III, St. Augustine, FL (US); Yu-Dong Yao, Basking Ridge, NJ (US); Yingying Chen, Morganville, NJ (US); Hong Man, Short Hills, NJ (US)

(21) Appl. No.: 13/298,781

(22) Filed: Nov. 17, 2011

Related U.S. Application Data
(63) Continuation-in-part of application No. 13/084,835, filed on Apr. 12, 2011.
(60) Provisional application No. 61/323,097, filed on Apr. 12, 2010.
(60) Provisional application No. 61/415,474, filed on Nov. 19, 2010.
(60) Provisional application No. 61/414,644, filed on Nov. 17, 2010.

(51) Int. Cl. G06F 9/38

(52) U.S. Cl. 712/241; 712/E09.045

(57) ABSTRACT

A method and apparatus are disclosed that may comprise applying compact markup notation to a general recursive computing system including hardware and software components, the compact markup notation defining things, places, paths, actions and causes within at least one of the hardware and the software of the general recursive computing system, to establish a set of data comprising a definitive description of the general recursive computing system in the compact notation; and synthesizing a self-aware and self-monitoring primitive recursive computing system utilizing the definitive description in the compact markup notation.

### CROSS-REFERENCE TO RELATED APPLICATIONS

The present application is a continuation in part of U.S. patent application. Ser. No. 13/084,835, filed on Apr. 12, 2011, entitled METHOD AND APPARATUS FOR IMPROVED SECURE COMPUTING AND COMMUNICATIONS that claims priority to U.S. Provisional Patent Application. No. 61/323,097, filed on Apr. 12, 2010, entitled INHERENTLY SECURE COMPUTING AND COMMUNICATIONS, and the present application claims priority to U.S. Provisional Patent Application No. 61/415,474: filed on Nov. 19, 2010, entitled COGNITIVE LINGUISTICS BEHAVIOR MODELING AND RELATED PROCESSES, and to U.S. Provisional Patent Application No. 61/414,644 filed on Nov. 17, 2010 and entitled INSTRUCTION SET ARCHITECTURE FOR SELF-AWARE INHERENTLY SECURE COMPUTING AND COMMUNICATIONS, the disclosures of all of which are hereby incorporated by reference for all purposes as if these prior applications were completely and fully reproduced in the present application.

### STATEMENT REGARDING FEDERALLY SPONSORED RESEARCH

Some of the research performed in the development of the disclosed subject matter was supported by the U.S Department of Defense under USAF Contract No. FA8240-07-C-0141. The U.S. Government may have certain rights with respect to this FA8240-07-C-0141. The U.S. Government may have certain rights with respect to this application and invention. The DoD requests that the US Patent and Trademark Office Redact the USAF contract number from public disclosure.

### FIELD OF THE INVENTION

The disclosed subject matter relates to a computer and computing architecture for computing and communication use and particularly to a more secure architecture. The architecture may employ primitive recursive functions. the disclosed subject matter more particularly relates to methods and apparatus for automatically converting conventional computing and communications systems into a more secure primitive recursive architecture and hardware apparatus. More particularly the more secure architecture can embed all data into its hardware apparatus (a “self”). As such, the data may be no longer generic, readable by people or by general purpose computing or communications devices, but instead can be configured, coded, and otherwise manipulated so as to be “self”-dependent. That is, dependent on the hardware “self” and thus may be effectively or efficiently useful only by a the specific hardware apparatus “self,” by which such data as may be used by the “self” may be configured.

### BACKGROUND OF THE INVENTION

There is a need for securing computing and communications to render servers, server farms, and related computer networks immune to such attacks and security threats as hacking and the like. Simultaneously there is a need to defeat all categories of virus, worms and other malware. A goal would be to protect personally identifiable data from theft. Thusly, digital rights management can be achieved, e.g., for media such as music and video. also possible is the ability to more fully protect drawings, descriptions, computer aided designs, and other intellectual property embedded in such data.

There is also a need for securing signal processing applications such as radio and radar, which can yield much greater resiliency and security of U.S. and global Defense systems. The process of formulating, designing, implementing, testing, deploying, and supporting such improved secure computing, communications, and signal processing systems via new designs and via reusing existing designs can be exceedingly labor-intensive and error prone, inducing myriad security vulnerabilities to penetration into the implemented apparatus.

The subject matter of U.S. patent application Ser. No. 13/084,835, filed on Apr. 12, 2011 “METHOD AND APPARATUS FOR IMPROVED SECURE COMPUTING AND COMMUNICATIONS” (“the '835 application”) describes how general recursive computing is a root cause of security vulnerabilities of computing and communications and how to eliminate those vulnerabilities. the subject matter of that application relates to a computing and communications method that may comprise: utilizing a primitive recursive function computing engine including an instruction set architecture prohibiting loop operations that continue for an indefinite time in order to perform computing functions. The disclosed subject matter may also include the instruction set architecture comprising the utilization of system identifiers selected from a group comprising things, places, paths, actions and causes. A particular instruction set architecture is also described, which may include utilizing a compact markup notation to define the roles of things, including the notations including enclosing the type of thing within symbols defining the role of the thing., as an example, including (thing), [place], {path}, /action\ and <cause>. Such a system, method and architecture can result in improved secure computing and communications.

### SUMMARY

A method and apparatus are disclosed that may comprise applying compact markup notation to a general recursive computing system including hardware and software components, the compact markup notation defining things, places, paths, actions and causes within at least one of the hardware and the software of the general recursive computing system, to establish a set of data comprising a definitive description of a computing system in the compact notation; and synthesizing a self-aware and self-monitoring primitive recursive computing system utilizing the definitive description in the compact markup notation.

The disclosed subject matter in the present application can add to the disclosed subject matter in the '835 application in part, concerning the apparatus using the primitive recursive instruction set architecture and concerning the related processes and mechanisms there disclosed and claimed. the disclosed subject matter of the present application also compliments the disclosure of the '835 application in part concerning the methods of compact markup notation for things, places, paths, actions, and causes, e.g., as relates to defining commonly understood hardware in such terms. Also the disclosure of the '835 application is supplemented in part concerning the methods and apparatus for the affordable implementation of the improved computing and communications apparatus and methods.

A large amount of time and cost potentially needed to accomplish non-trivial implementations incorporating existing hardware, software and data structures and content in order to implement the improved secure computing and communications of the type disclosed in the '835 application may be seen as a roadblock to transitioning from the use of an existing network of computing and communications devices to the use of improved secure computing and communications disclosed in the '835 application.

The '835 application proposed mechanisms for performing computing and communications, however, there methods or apparatus are also needed to also utilize beneficial aspects and elements of existing computing or communications hardware apparatus, while also realizing aspects of embodiments of the disclosed subject matter of the '835 application. Beneficial and efficient use of data associated with such existing apparatus, methods and architectures can realize even further improvements to the apparatus, methods and architectures of the '835 application. Use of existing software, firmware, comments, user data, and documentation within the apparatus, methods and architectures of the '835 application can also be realized according to aspects of the subject matter disclosed in the present application.

Applicants therefore propose a method and apparatus for the application of the compact markup notation of Claims 10 and 11 of the '835 application to an example of an existing system. As contemplated the result includes a set of data termed the definitive description of such secure computing or communications systems. A method and apparatus for the automatic analysis of the definitive description of exemplary existing systems using methods according to aspects of the disclosed subject matter are presented. A method and apparatus to transform the beneficial elements and behaviors of such an existing system or systems guided by a compact description of the improved system employing the subject matter disclosed in the '835 application is proposed.

The proposed method and apparatus can, as an example, automatically synthesize from the compact description a definitive description of applicable hardware and software for an improved secure computing or communications system. The proposed method and apparatus can also automatically translate the definitive description of the improved system into an improved secure communications and computing apparatus, including, by way of example, automatic generation of the associated data embedded into the apparatus and method. Such embedded data can provide for its operation, use, and behavior with the improved security of the compact description from which it was automatically synthesized. Such automation can, for example, eliminate the possibility of the introduction of security vulnerabilities such as human-induced errors or of hardware, software, human behavior, or any other elements that induce any behavior whatever that is not specifically delineated in the compact description.

The result of the disclosed method and apparatus can include reducing the cost of the continuing use of existing systems, methods and architectures substantially. The result can also include suppressing security vulnerabilities such as those related to general recursion in existing systems. Additionally a result may be to, e.g., significantly eliminate the possibility of human induction of errors of omission or commission that could induce security vulnerabilities into the resulting improved computing and communications apparatus.

As used hereinafter, the terms “automatic” and “automatically” include the property that an automatic apparatus accomplishes a task so as to require no human intervention in the performance of that task, and, rather is not intended for human intervention, and protects itself from human intervention.

### BRIEF DESCRIPTION OF THE DRAWINGS

For a more complete understanding of the present invention, reference is made to the following detailed description of exemplary embodiments considered in conjunction with the accompanying drawings, in which:

FIGS. 1(a) through 1(e) show examples of behavioral notation and an exemplary apparatus for mobile (things) including exemplary pulses which can be utilized according to aspects of embodiments of the disclosed subject matter;

FIG. 2 shows examples of a utilization of the method of behavioral notation and exemplary apparatus according to aspects of embodiments of the disclosed subject matter;

FIG. 3 shows further examples of the utilization of the method of behavioral notation and exemplary apparatus according to aspects of embodiments of the disclosed subject matter;

FIG. 4 shows further examples of the utilization of the method of behavioral notation and exemplary apparatus according to aspects of embodiments of the disclosed subject matter;

FIG. 5 shows further examples of the utilization of the method of behavioral notation and exemplary apparatus according to aspects of embodiments of the disclosed subject matter;

FIG. 6 shows an example of the operation of an exemplary apparatus and method according to aspects of embodiments of the disclosed subject matter;

FIG. 7 shows an example of the operation of an exemplary apparatus and method according to aspects of embodiments of the disclosed subject matter;

### DETAILED DESCRIPTION OF EXEMPLARY EMBODIMENTS

According to aspects of embodiments of the disclosed subject matter, applicants propose mechanisms for representing and performing computing and communications. Specifically, applicants propose the utilization of all of the (things), [places], {paths}, /actions\, and <causes> in existing hardware and software that comprise an existing hardware/software system via a novel use of the compact markup notation of the '835 application. Such utilization can further enable the isolation within a resulting definitive description of the beneficial (things) (and their associated [places], {paths}, /actions\, and <causes>) for the utilization of existing hardware/software methods and apparatus. Such utilization can allow for manipulation of the resulting definitive description of (things), and their associated [places], {paths}, /actions\, and <causes>) according to the compact markup notation of the '835 application.

Further such utilization can allow for the creation of a resulting hardware apparatus and of the associated resulting definitive description data things embedded in that hardware that may cause that apparatus to behave as desired, i.e., to provide optionally, from a user perspective, functionally identical hardware and hardware dependent data of improved security. From an engineering perspective, a functionally similar system of enhanced secure or optimized secure versions of one or more existing systems can result. A definitive description of a (thing) such as a system S thing (S), or an instance of hardware dependent data (“DD”), dependent on the system S (thing), i.e., a (DD-S) system dependent data thing embedded into the system S (thing) (S), e.g., as hardware dependent data, may realize a comprehensive organization plan (“COP”) thing for the system S (thing), i.e., (S), as disclosed in the '835 application.

According to aspects of embodiments of the disclosed subject matter, the proposed methods and apparatus can include:
(1) The compact notation and method of the '835 application and use of that notation to describe comprehensively and definitively the functional behavior of an existing formal system such as of computer hardware, firmware, software or protocol stacks, etc.
(2) The compact notation and method of the '835 application and use of that notation to describe comprehensively and definitively the functional behavior of an existing informal system such as such as expressing [tasks performed by people as /actions\, and <causes> of those behaviors of people in the system based on the (things) used and on interactions with such (things) by such people in [places] of the system such as a screen display, which [places] may be configured into {paths} such as a series of data entries in a screen display, regarding which a person may perform an /action\ such as updating the (data) of the {data entry sequence} of that [display] where the people also considered as things. Such functional behavior can be based further on such as the concrete physical and abstract [places] of which people conceive, use, and with which otherwise interact with such things. Such functional behavior can in addition be based further on the ways in which people organize their actions into {paths} consisting of such sequences of such concrete and abstract [places]. Alternatively the basis can be the /actions\ consisting of abstract and concrete (things) moving along such {paths}. In addition the distinct <causes> that initiate, terminate, control, and constrain such actions employing the compact notation of the '835 application, (thing), [place], {path}, /action\, and <cause>, and along with corresponding graphical notations as may be convenient may form such bases.
(3) The apparatus and method to automatically generate a definitive description of existing and envisioned formal systems and methods and apparatus-dependent data functionally comparable to conventional computer and communications computer aided design (CAD) descriptions of conventional computing and communications hardware as an example. Apparatus-dependent data comparable to conventional software based on that notation and apparatus-dependent data which may serve as a gold-standard against which to compare implementation apparatus and data of such formal systems, e.g., from un-trusted supply chains and, e.g., after in-situ maintenance by un-trusted people may be effected.
(4) The apparatus and method to generate the definitive description of hardware apparatus employing the textual compact notation of the '835 application, (thing), [place], {path}, /action\, and <cause>, and with corresponding graphical notations as may be convenient.
(5) The apparatus and method to perform a definitive mapping of definitive descriptions and compact notation into associated apparatus functions among constrained subsets of conventional hardware instruction set architectures, such as, logic gates and memory and among constrained subsets of conventional computer languages such as C, C++, Matlab, and others. Aspects may convert among such formal languages and automatically constrain and limit the resulting definitive descriptions and resulting apparatus to the primitive recursive structures of the '835 application. This also can employ the textual notations of (thing), [place], {path}, /action\, and <cause>, and with such corresponding graphical notations as may be convenient.
(6) The apparatus and method to translate the functions and structure of the definitive description of an improved secure system via the methods and apparatus disclosed in the present application to then become hardware apparatus and associated embedded hardware-dependent data realizing the improved secure computing and communications disclosed in the '835 application. These may include assurance of primitive recursion and related security properties via the embedding of (things), [places], {paths}, /actions\, and <causes> in an instruction set architecture. An arrangement of unidirectional and parallel paths as disclosed in the '835 application may be utilized. Redundancy and self-reference to assure robust and error free behavior may be utilized. The present application further discloses proposed embodiments of a detailed instruction set architecture (ISA).
(7) The apparatus to embed a definitive description of an improved secure system within all of the elements of such an improved secure system (referred to as the “self”) in such a way that the improved secure system may inspect itself with respect to its own definitive description. The inspection may occur at any level and in any such way as may be required to assure continuous and uninterrupted conformance of the improved secure system to its own definitive description. Thus aspects of embodiments of the disclosed subject matter can as an example realize an apparatus of improved security and robustness.

Those skilled in the art will understand that methods 1-3 and apparatus 4-7 summarized above can be employed, e.g., to synthesize a self-aware self-monitoring computing and communications system providing improved security via the method and apparatus of the '835 application. Direct usage of beneficial aspects of existing systems and the transformation of definitive descriptions and compact notations can be utilized to improve the security of a derivative improved secure system. such may be accomplished with respect to the apparatus, and thus eliminate large, costly systems design, hardware design, and computer programming and testing efforts otherwise required. At the same time aspects of the disclosed subject matter can realize a complete, consistent primitive recursive system and method of apparatus and apparatus-dependent data embedded into that apparatus. A resulting improved secure system can exhibit behavior of an improved secure computing and communications apparatus that embodies, e.g. the details of instruction set architecture (ISA) of the '835 application. As disclosed in more detail below, with the associated hardware apparatus of such optimized and secure ISA, created by that apparatus disclosed in general above and in greater detail below, aspects of the disclosed subject matter can perform the analysis and modification of the non-secure designs and non-secure realizations of conventional computing and communications hardware, firmware, software, and communications protocols and arrive at a synthesis of apparatus conforming to the methods of the '835 application and aspects of the disclosed subject matter of the present application.

### Automated Analytic Apparatus

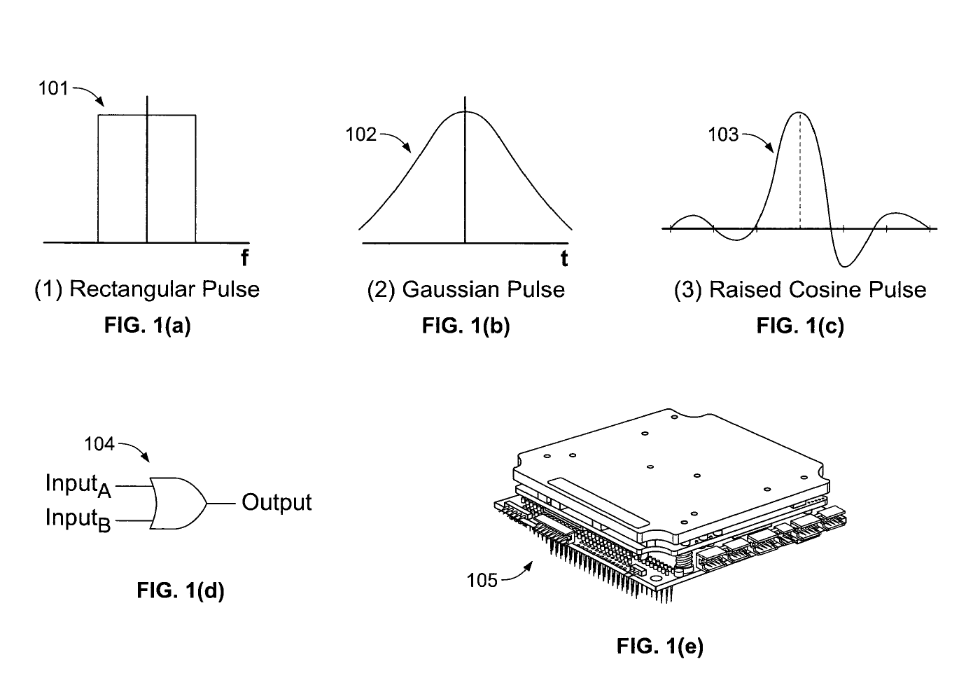

According to aspects of embodiments of the disclosed subject matter, FIGS. 1-5 describe exemplary methods and hardware apparatus by which the compact notation of the '835 application, (thing), [place], {path}, /action\, and <cause> can be ascribed to and may become embedded in a hardware apparatus. The notation can be ascribed as complete and self-referentially consistent data integral to and dependent upon such hardware apparatus. This data can thus comprise hardware-dependent data.

According to aspects of embodiments of the disclosed subject matter, FIG. 1 describes exemplary methods and hardware apparatus for mobile and fixed (things). In a digital system such as a computer, digital controller, or digital communications device with wire or fiber optic communications channels such as Ethernet, the prototypical or canonical moving (thing) may be a pulse, e.g., a rectangular pulse 101 of FIG. 1(a). The time duration of such a pulse 101 in general may be less than a nanosecond or in the case of a more general pulse 101 may endure for seconds, minutes, or hours or more. A pulse 101 of long duration may be termed by one skilled in the art as a binary level signal that is in the ON state during such a pulse and that is in the OFF state before and after such a pulse.

Digital devices interacting with such a mobile (thing) as digital pulse 101 may respond to the ON state of the pulse, to the OFF state of the pulse, or to the transition from OFF to ON or to the transition from ON to OFF or to some other aspect of such mobile pulse (things) 101 such as ternary states that are neither ON nor OFF or to some other aspects of such pulses as may occur and as will be understood by one skilled in the art.

According to aspects of embodiments of the disclosed subject matter, a pulse 101, such as that of FIG. 1(a) may be specified in compact notation as a specific pulse (thing) that may be specified, e.g., in terms of volts and time as (pulse (volts, time)). The states of volts may be defined in the compact notation of the '835 application as, for example, (volts (OFF, ON)). The states of time may be specified in compact notation, for example, as (time (start, turn-ON, zero, turn-OFF, end)). Aspects of the pulse (thing) may be further specified as (OFF (0 volts)) and (ON (1.5 volts)). Relationships between volts and time may be further specified in compact notation of the mobile pulse (thing) in terms of voltage and time (things) as (pulse (volts, time) (OFF, start), (ON, turn-ON), (ON, zero), (OFF, turn-OFF), (OFF, end)). This may be briefly referred to as the (thing) (pulse (volts, time) behavior). According to aspects of embodiments of the disclosed subject matter, pulse 101 of FIG. 1(a), specified in compact notation as (pulse (volts, time) behavior) may be incorporated into an apparatus that employs such pulses as apparatus-dependent data.

According to aspects of embodiments of the disclosed subject matter, compact notation for mobile (things) like pulse 101, comprising an expression such as (pulse (volts, time) behavior), may be incorporated into an apparatus and as such may also constitute self-descriptive apparatus-dependent data or briefly self-description in compact notation, which may be designated in the compact notation as a thing (self(pulse (volts, time) (OFF, t<−1), ON, (−1<t<1), (OFF, t>1))) as illustrated graphically in FIG. 1(a).

According to aspects of embodiments of the disclosed subject matter, FIG. 1(b) may describe, alternatively, e.g. an analog system such as a wireless local area network or other radio communications system in which the signal in space, as is known to those skilled in the art, may have a channel symbol. The channel symbol may comprise a prototypical moving (thing), e.g. that moves from transmitter to receiver, such as the Gaussian pulse 102.

Such a Gaussian pulse 102 of FIG. 1(b) may be specified in compact notation as a specific pulse (thing) that may be specified, e.g. in terms of time and signal strength in milli-Watts or in decibels, such as (pulse (time, mW)), with the states of the signal defined in the compact notation of the '835 application as for example in a discrete version of the trace of FIG. 1(b), e.g. in a form such as: (pulse (time, dB) (−1, 0.03) (−0.9, 0.04) . . . etc.) briefly referred to as (pulse behavior) when there is no ambiguity or briefly and unambiguously referred to as (This Patent Application (FIG. 1 ((pulse 102) behavior))). The compact notation for pulse 102 behavior may be embedded into an apparatus that employs such pulses as self-descriptive apparatus-dependent data.

According to aspects of embodiments of the disclosed subject matter, FIG. 1(c) may describe, alternatively, e.g. a hybrid analog-digital system such as a high resolution radar, or LIDAR apparatus, in which, as an example, a prototypical moving (thing) may be a pulse that is shaped to optimize its usefulness, e.g., in sensing distance, such as a raised cosine pulse 103, for example.

Those skilled in the art may term such moving (things) as pulses 101, 102 and 103 with the name signals. According to aspects of embodiments of the disclosed subject matter, FIG. 1 may describe, alternatively, e.g. a hybrid analog-digital (thing) such as a video device in which the mobile (thing) may include a rectangular pulse 101 in the role of a <cause>, which may, e.g., initiate, modulate, or terminate sensing. The video device (thing) may, in turn, employ another mobile (thing) such as a shaped pulse, similar to shaped pulse 102 or shaped pulse 103, to reflect sensed values from video sensor elements such as a charge coupled device known to those skilled in the art of video sensor systems.

According to aspects of embodiments of the disclosed subject matter, the compact notation for the rectangular pulse 101 as a (thing) (101), for the Gaussian pulse 102 as a (thing) (102), etc. If it may be necessary or useful for a human being to read the compact notation (101), a thing (101) may be expressed for human understanding more generically as (rectangular pulse), or more explicitly as (This Patent Application (FIG. 1 (101 (rectangular pulse)))). The method of enclosing the notation for (things), e.g., (101) within the notation for a larger thing (This Patent Application) can be seen to illustrate a method of compact notation for expressing a physical relationship among those (things) in which the smaller thing (the pulse description) is enclosed within the larger thing (this patent application).

The method for self-reference employing the term “this” for self-reference to a (thing) itself may be known to those skilled in the art e.g. of object oriented programming. The application of notation claimed in the '835 application with reference to such a layered hierarchy of things from (this Patent Application) to (rectangular pulse 101) makes containment of one thing within another compact to a degree not realized with known methods such as with an object oriented design, with object oriented programming or with the ontology of the semantic web, all of which as will be known to those skilled in the art.

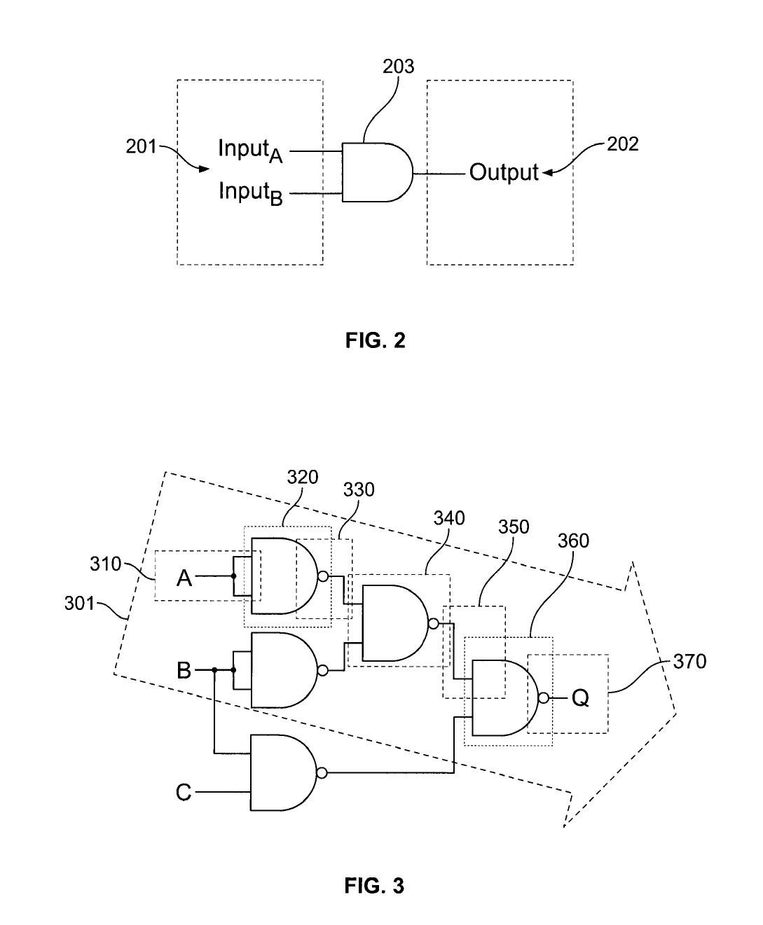

According to aspects of embodiments of the disclosed subject matter, FIG. 2 further defines a method for marking up descriptions of existing hardware devices using the compact notation of the '835 application, i.e., (thing), [place], {path}, /action\, and <cause>. In a digital system such as a computer, digital controller, or digital communications device, there may be many discrete devices such as the logical OR gate 104, marked up as (thing) (104) via the compact notation. If it may become necessary or useful for a human being to read the compact notation, thing (104) may be noted generically as (OR gate), or may be more explicitly noted as (This Patent Application (FIG. 2 (104 (OR gate)))). This particular (OR gate) may provide an example of an abstract thing since there is no additional context to specify which (OR gate) is being referred to.

According to aspects of embodiments of the disclosed subject matter, FIG. 1(d) can further define a preferred method for describing in compact notation those larger accumulations of hardware devices that may be packaged together. Using the compact notation in a digital system such as a computer, digital controller, or digital communications device, there may be many aggregated devices such as a VLSI chip 105, marked up as (thing) 105 via the compact notation (105). If it becomes necessary or useful for a human being to read the notation, thing (105) may be noted generically as (VLSI circuit), or may be more explicitly noted as (This Patent Application (FIG. 1(d) (105 (VLSI circuit)))). This particular (VLSI circuit) is an example of an abstract thing since there is no additional context to specify which (VLSI circuit) is being referred to. If the abstract thing (FIG. 1 (105 (VLSI circuit))) could be said to contain or to be allowed to contain an (OR gate), that fact may be compactly noted as (105 (104)) or more explicitly for human readability as (FIG. 1(d) (105 (VLSI circuit (OR gate)))).

According to aspects of embodiments of the disclosed subject matter, an existing system E may be noted as a (thing) via the compact notation (E). To note that (E) contains hardware, firmware, software, and people, the compact notation allows one to write the compact notation: (E (hardware (firmware)) (software)(people)). The containment of the (firmware) within the (hardware) can be used to indicate that the firmware is embedded in the hardware and that there is no other firmware within E. This could be the case with a typical laptop computer because a typical processor chip in a laptop typically contains firmware, but typically there is no copy of that firmware in the laptop's memory or hard drive. In addition, the behavior of people that use, maintain, support, or otherwise come in contact with system (E) may be noted generically or specifically. For example, the fact that E is Joe's laptop may be noted as

Note A: (laptop (E (people (Joe))))

This notation can be used to place the specific system (E) within an abstract thing (laptop), establishing that (E) is a laptop computer and the collection of people noted as interacting with (E) includes (Joe). The relationships of Note A may be described in the compact notation and Note A itself may be embedded in the system (E), thereby informing the system (E) that it knows and may interact with Joe.

According to aspects of embodiments of the disclosed subject matter, an improved secure system thus may be a (thing) E containing only the (hardware), (firmware), (software), and (people) things whose behavior is noted in expressions like Note A embedded in (E), where (E) fully embodies a system such as is described in the '835 application, e.g., including a primitive recursive instruction set architecture in detail as described in compact notation like Note A that is embedded in the system, Such embedding can be done in a way that the system itself can employ Note A to modulate its own behavior, such as to interact only with (people) named (Joe). The embedding of self-referential apparatus-dependent data such as Note A within system (E) and the use of such data items to modulate behavior may constitute what is referred to in the present application as self-awareness.

The compact notation for mobile and fixed hardware things of FIGS. 1(a)-(d) and Note A can serve to identify a (system), its (elements) and (components), and containment relationships among these (things). One may also ignore many details and aspects of connectivity and behavior that may be important for some purposes, deferring the arrangement of complete and consistent definitive description to larger configurations of (things), [places], {paths}, /actions\, and <causes> as more fully disclosed below.

According to aspects of embodiments of the disclosed subject matter, FIG. 2 shows the behavioral notation and exemplary apparatus for hardware [places] including an exemplary [input place] 201 and an exemplary [output place] 202 at which mobile and fixed hardware (things) may interact with each other. As an example, the interaction can be with respect to an exemplifying (fixed thing) logic AND gate 203. The exemplary [Input A] 201A and [Input B] 201B can comprise exemplary [input place 201] of the fixed Logic AND gate thing (203). The place [input 201 [Input A]] can provide compact notation for a specific [place] in which a mobile (thing) such as (pulse 101) may interact as a mobile (thing) with the fixed reference (thing) (AND gate 203), i.e., the logical AND gate.

According to aspects of embodiments of the disclosed subject matter, the compact notation for the input place 201 as a place is [201]. If it may be necessary or useful for a human being to read the compact notation [201], place [201] may be expressed more generically as [Input], or more explicitly as ([This Patent Application [FIG. 2 [201 Input]]]). In the apparatus of FIG. 2, a [place] itself takes on the role of a (thing) when referred to in the abstract, which is referred to in the present application as a meta-level reference, and thus may be also noted as a thing ([place]). Enclosing places within other places or things may follow the form of enclosing things within other things wherein the enclosed things have the role of specifying places as can be illustrated by this more explicit detailed notation.

A method for self-reference employing the term “this” for self-reference in the role of a place may be appreciated by those skilled in the art. Application of compact notation with reference to a layered hierarchy of (things) can make containment of one place within another place explicit and formal to a degree not realized via known methods such as via object oriented design, object oriented programming or the ontology of the semantic web, all of which are known to those skilled in the art.

As is well known to those skilled in the art, the (AND gate) 202 of FIG. 2 may be concrete or abstract. If not otherwise specified, according to embodiments of the methods disclosed in the present application, the abstraction may be a (thing), such as an (AND gate) noted as such, and may be an abstraction following a behavior that may be defined as proposed in the '835 application. As an example, the behavior may be defined by a lookup table of a memory based transform (MBT), in which MBT the input levels 0 at Input A and 0 at Input B result in 0 at the Output, while input levels 1 at Input A or B but not both results in 0 at the Output, while input levels 1 at Input A and B at the same time results in 1 at the Output. This may be noted in detail as (AND gate [InputA][InputB][Output] [[000; 010; 100; 111]]) and noted briefly as (AND gate (behavior)). In other words, the response(s) of the look up table to inputs 00. 01, 10, and 11 may be the behavior of a concrete (AND gate) thing.

As is known to those skilled in the art, a concrete (thing), such as an (AND gate) also may be somewhat abstract and somewhat concrete at the same time. As an example, a (Xilinx#abc (#xyz (AND gate))), where Xilinx™ is a widely known manufacturer, #abc is a manufacturer's part number, and #xyz is a designator for a specific (AND gate) for that particular part. If that Xilinx device happens to be located in an existing system E and if there is only one such part in E, the notation (E (Xilinx#abc (#xyz))) specifies that specific (AND gate). Such (AND gate) may finally be a concrete device of an existing system E.

According to aspects of embodiments of the disclosed subject matter, a concrete device of the type (Xilinx#abc) may be employed as a component of a self-aware secure computing and communications system (S) if and only if along with that device, data of the form (S (Xilinx#abc (#xyz (#123)))) may be incorporated into the definitive description of (S) itself and further as may be derived from the methods of this disclosure discussed further below, the serial number of part (Xilinx#abc (#xyz)), such as by way of illustration, may be the numeric thing (#123) that may appear on that particular part. Thus (#123) may be read physically (e.g. via a video sensor of S) and electronically (e.g. via a self-employed ATE or internal electronic connections, test ports, or busses as will be understood by those skilled in the art). A definitive description of a specific concrete (AND gate) may be noted compactly as (S (Xilinx#abc(#123 (#xyz (AND gate)))). As indicated the (AND gate) may be embedded into system (S) to give system (S) a particular degree of awareness of AND gate #xyz. Such may arise because of a particular use of (S) itself including self-monitoring, self-configuration of hardware or of embedded data, which data as re-configuration often may be termed “self-programming” by those skilled in the art of conventional systems, and self-destruction in whole or in part, such as is discussed in the '835 application and is further disclosed below.

According to aspects of embodiments of the disclosed subject matter, a concrete (AND gate) thing may be expected to exhibit the (AND behavior). The (AND behavior) may then constitute a standard for the input-output behavior of the device (Xilinx#abc (#xyz)). The device may be tested against such standard. Parallel and pipelined data things such as are disclosed in the '835 application may employ the standard in parallel with the operation of the (device), comparing results to enforce the consistency of behavior of such an (AND gate) thing with respect to [input] [output] places defining a certain behavior over time and during other conditions, such as during a power failure or tamper condition.

It will be understood that, as discussed in the present application, an abstract (AND gate) 203 may refer to a concrete device with compact notation regarding the behavior of such a concrete device in domains other than time, voltage, input, or output. For example, those skilled in the art may define the power dissipation of such a device, which may be compactly noted for some part number #xyz as ((AND gate (#xyz)) (volts, power) (ON, 15) (OFF, 0.002)). From other compact notations, power can be considered to be represented in milli-Watts. By embedding this compact notation within the device #xyz, the larger system (S) may become power-aware with respect to such a device.

According to aspects of embodiments of the disclosed subject matter, an abstract (AND gate) 203 may refer to a concrete device with compact notation regarding the behavior of such a concrete device in different domains. For example, those skilled in the art may define, e.g., on the layout of an integrated circuit chip, the footprint of such a device in square nanometers, such as (AND gate (part number (#xyz)) (surface area (20 (square nanometers)))). In such compact notation, the units of measure are provided with the values of those metrics for that type of device so that there need be no prior arrangement regarding units of measure. By embedding this compact notation within the device #xyz, the improved secure system of the '835 application may become aware of device surface area within a chip with respect to such an (AND gate) device.

According to aspects of embodiments of the disclosed subject matter, an improved secure system, such as is discussed in the '835 application, may employ device surface area data to check the consistency of chips to be inserted into the system itself with the standard for such devices. A self-aware factory, for example, may automatically observe and measure device surface area under a microscope to verify, e.g., that chips from un-trusted sources conform to the standard surface area, power dissipation, and to other standards in multiple domains without the necessity of human intervention that could introduce undetectable errors into self-verification. For hardware [places] including an exemplary [input place] 201 and an exemplary [output place] 202 mobile and fixed hardware things may interact with each other, such as, with respect to the example of a logic (AND gate) fixed (thing) 203. To summarize, [Inputs (201A, 201B)] and [output (202)] of the fixed Logic (AND gate) thing (203) are, for purposes of the present application, [places] in which (pulses) interact as mobile (things) with the fixed (reference thing) (AND gate) 203.

According to aspects of embodiments of the disclosed subject matter, FIG. 3 shows the behavioral notation and exemplary apparatus of a hardware {path} 301 via with which mobile (things) such as (pulses 101) may interact with fixed (things) such as (AND gates) 203 including realized by an exemplary cascade 301 of [places] employing an exemplary ordered sequence 301 constituting a {path}. In compact notation, {301} represents {path} 301. In compact notation place {path}301 may be specified as an ordered sequence of places: {301 [310] [320] [330] [340] [350] [360] [370]}.

This sequence comprises first an [input place] 310; and next a (thing) such as an exemplary logic gate 320 that behaves as a [place], i.e., for logical processing. Next is an output [place] 330 of exemplary logic gate (thing) 320, which can comprise at the same time an input [place] 330 of logic gate (thing) 340, which also behaves as a [place] 340, i.e., for logical processing. Next in the {path} 301, the logic gate (thing) 340 leads to an output [place] 350 of exemplary logic gate (thing) 340, which comprises at the same time an input [place] 350 to logic gate (thing) 360. Further, the logic gate (thing) 360 behaves as a [place], e.g., for logical processing in sequence in cascade along the path {301}. Finally, as an example, there is an output [place] 370. The places 310-370 in that sequence of the path {301} are the compact and definitive description of {exemplary hardware path} 301. To summarize, A {path (301)} through the sequential logic circuit elements shown in FIG. 3 can constitute a sequence of [places]. The sequence can begin, e.g., with an input place A [310] and proceeding in order through things (320), (340), and (360), each also behaving as a place for logical processing, with their associated input places [310], [340], [350] and output places [330], [350], [370]. The path {310} transforms a mobile thing such as an input pulse at [A] 310 into another mobile thing such as an output pulse at [Q] 370 (pulses not shown).

According to aspects of embodiments of the disclosed subject matter, an abstract {path} 301 may refer to a concrete sequence of (things), i.e., devices 310-370 with compact notation regarding the behavior of such a concrete devices in domains such as time delay, run length, voltage, power, input, and output. For example, those skilled in the art may define the time delay of input 310 as 3 nanoseconds, which may be expressed in compact notation as: [[(Input 310)] [time delay] [3 (nanoseconds)]]. The time delay in this case can be expressed as a place role noted as [time delay] with respect some concrete thing (Input 310) that may be required to realize the function of a place [Input 310], such as, a wire or connector.

An abstract {path} 301 may include a concrete device 320 with compact notation regarding the behavior of such a concrete device 320, in relevant domains such as time delay as, e.g.: [[(gate 320)] [time delay] [4 (nanoseconds)]]. According to the compact notation ([time delay]+[time delay]=[time delay]) may establish that time delay is an additive property, e.g., of these connectors, wires, gates, and other physical things that realize the abstract {path} 301, or some portion of that {path}.

According to aspects of embodiments of the disclosed subject matter, an improved secure system may employ device time delay data to check the consistency of chips to be inserted into the system itself with the standard for such devices. A self-aware factory, for example, may automatically observe and measure device time delay to verify that chips from un-trusted sources conform to standard time delay. Other properties of {paths} such as surface area, power dissipation, and other measurable properties may be compared to other standards, e.g., in multiple domains without the necessity of human intervention that could introduce undetectable errors into self-verification.

According to aspects of embodiments of the disclosed subject matter, the description of an existing (system) thing, in terms of the compact notation for (things) and [places] within {paths} may be inferred by testing existing devices in multiple domains such as time, voltage, power, time delay, surface area, etc., without the necessity of human intervention that could introduce undetectable errors into the characterization of an existing system. The apparatus by which to perform such testing may be comparable to automated test equipment (ATE) with test harnesses and measurement circuits known to one skilled in the art.

The employment of {paths} as illustrated in FIG. 3 above and as further described to definitively describe existing digital, analog, and hybrid analog-digital electronic systems would be a completely novel method to one skilled in the art of test equipment, defining a completely novel data structure and apparatus, e.g., realizing the '835 application. ATE functions can be realized for reverse-engineering of an existing system to yield its definitive description without human intervention that may introduce undetected errors.

Within the hardware {path} 301, where mobile (things) may interact with fixed (things) including realized by an exemplary cascade {path} 301 of places employing an exemplary ordered sequence of the {path} 301 from an [input place] 310. Next a (thing) 320, i.e., the exemplary logic gate 320 that behaves as a [place] for logical processing provides an output pulse (thing) (not shown) to the output [place] 330 of exemplary logic gate (thing) 320. The output place 330 at the same time comprises an input [place] 330 of logic gate (thing) 340, also acting as a [place} 340 for logic processing. The logic gate (thing) 340 in the sequence in cascade of the {path} 301 provides an exemplary output [place] 350 of exemplary logic gate (thing) 340, comprising at the same time an input [place] 350 to logic gate (thing) 360. This next a logic gate (thing) 360, that also behaves as a [place] 360 for logical processing, also leads to the exemplary output [place 370]. The [places] 310-370 thereby defining the exemplary hardware {path} 301.

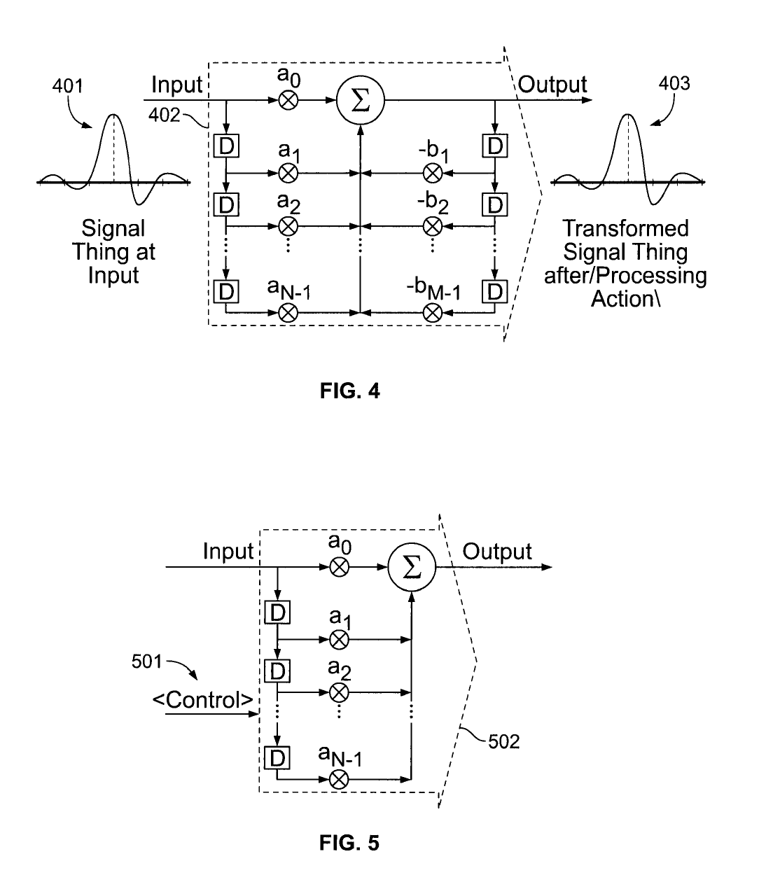

According to aspects of embodiments of the disclosed subject matter, FIG. 4 shows the behavioral notation and exemplary apparatus for the hardware /action\ of an exemplary signal (thing) 401 being transformed by the /action\ of /moving through an exemplary filter path 402\ to yield an exemplary filtered signal (thing) 403. The signal (thing) at 401 may move along a {path} 402 that is implicitly defined by the (filter circuit 402) from a (402 [Input]) place to a (402 [Output]) place via the hardware /action\ that one skilled in the art may refer to more generically as /signal processing\ and more specifically as /(filter 402) processing (signal 401)\.

According to aspects of embodiments of the disclosed subject matter, FIG. 4 shows a hardware /action\ of /(filter 402) processing (signal 401)\ the concrete realization of which can require some amounts of (space), (time) and (mass) or (energy) or both (mass) and (energy). The compact notation of the '835 application may definitively describe, for example, the physical (mass), energy use per unit time (power) and (time delay) of (filter 402):

/(filter 402 (mass (0.1 (kilogram)) processing (signal 401) requires
(power (0.2 (Watts))) (time delay (30 (nanoseconds))))\.

The string “requires” in the compact notation above can reflect the English language usage of the term as do the terms mass, kilogram, etc. The compact notation may definitively describe actions, paths, places, and things via such human language as may be convenient for human understanding of such compact notation as formed according to the '835 application.

According to aspects of embodiments of the disclosed subject matter, the embedding of the data above that /(filter 402) . . . requires . . . \ into a system E that includes a filter (thing) (402) and that may generate a signal (thing) (401) can be considered to synthesize a self-awareness of E regarding the power and time delay needed to process (signal 401) in (filter 402). According to aspects of embodiments of the disclosed subject matter, the /action\ of /signal processing\ can be illustrative of actions that may be performed by an ATE apparatus in accordance. The apparatus may perform such an action by presenting a signal (thing) (401) to the filter (thing) (402), comparing the signal at (402 [Output]) to the (signal 403) to test (filter 402). In addition, an ATE may present a (signal 401) to a (filter 402) that exists within some existing system (E), recording the resulting (signal 403) in time and energy. this may be done, such as, with a probe apparatus and signal measurement apparatus known to one skilled in the art, such that the captured (signal 403) plus the input (signal 401) definitively describes the input-output behavior of (filter 402).

According to aspects of embodiments of the disclosed subject matter, the [Input port] and [Output port] of (filter 402) can provide access to the {Path 402} for /signal processing action\. Inside {path 402} can be located implicit and explicit [Places]. For example, there may be a definitive description of the (filter 402), which can provide additional detail, e.g. for the [(delay elements D)], providing a /time delay action\ and for a /multiplication action\ at [(devices a₁)] . . . [(aₙ₋₁)] and [(b₁)] . . . [(bₙ₋₁)] that may be described using the notation methods (thing), [place], and {path} of FIGS. 1, 2, and 3 and of an /action\.

According to aspects of embodiments of the disclosed subject matter, a (thing) such as a (filter 402) that performs a /signal processing action\ can define a {path from [input] to [output]} along which some (mobile thing), such as a pulse or a signal may move in order to perform that action. If no (mobile thing) is moving, then no /action\ may be performed. Things within such a {path} for /action\ may be anonymous such as delay elements (D) and multiplier elements (a) where i is an integer as indicated in FIG. 4.

Apparatus for the hardware /action\ of an exemplary (signal thing) 401 may be transformed by the /action\ of /moving through an exemplary filter {path 402} to yield an exemplary filtered signal (thing) 403. To summarize, illustrative design notation for signal processing hardware actions is illustrated. The signal (thing) 401 can move along the {path} 402 from filter circuit 402 [Input place] to [Output place] as a hardware /Action\. Input and Output ports provide access to the {Path 402} for this /action\. Inside this {path} are [Places] with a definitive description, e.g. for the delay elements D, and for multiplication devices a₁ . . . aₙ₋₁ and b₁ . . . bₙ₋₁ described using the (thing), [place], and {path} notation methods of FIGS. 1, 2, and 3.

According to aspects of embodiments of the disclosed subject matter, FIG. 5 illustrates an example of behavioral notation and exemplary apparatus for compact notation of <hardware cause>. In FIG. 5, <an exemplary control signal 501> initiates, controls, inhibits and otherwise may influence the operation of an exemplary signal processing {path} {502} of a filter (thing) (502). A clock pulse at <501 control> may initiate the signal processing flow through the {signal processing path 502} of the illustrative filter circuit 502 and may have the role of a <Cause> over {path 502} and thus over the operation of a digital filter circuit 502.

According to aspects of embodiments of the disclosed subject matter, the notation to delineate <cause 501> over {path 502} may be represented to the system itself as the compact definitive description <501 {502}> or equivalently for greater clarity for human consumption as <control 501 {path 502 ([Input] digital filter circuit [Output])}>.

For convenience in processing text descriptions, a form of compact notation of the '835 application may be employed, e.g., using an extensible markup language (XML) for tags such that (thing), [place], {path}, /action\ and <cause> are tags. The tags can convert the compact notation <501{502}> to the more verbose XML notation:

<cause> name=501<path> name=502</path></cause>,

in which the start of an XML tag is indicated with angle brackets <tag> while the end of that tag is indicated with the slash </tag> so that “<cause> name=501 </cause>” in XML expresses verbosely the fact that 501 is a cause, represented compactly as <501>, and further in this example, the text “<path> name=502 </path>” in XML expresses verbosely the fact that 502 is a path, represented compactly as {502}. Verbosity expands the number of characters, hence the number of bits employed to express relationships among things, places, paths, actions, and causes. A verbose XML form therefore may require a much larger number of characters and hence of bits to express facts needed for a comprehensive and definitive description of an existing system E and of an improved secure system S. Embedding self-referential descriptions into apparatus such as are shown by way of example in FIGS. 1 through 5 therefore can comprise the compact notation as opposed to XML notation wherever storage space is at a premium.

The compact notation of FIGS. 1 through 5 may be configured into definitive descriptions consisting of text in the compact notation and comprising descriptions of a computing and communications system consisting of digital or analog pulses, digital logic gates, digital signal processing, analog signal processing, collections of digital, analog, or hybrid analog-digital signals, and collections of processing elements. The elements may contain at their various levels embedded memories, parallel and serial data structures, etc., containing compact notation of the (self) of which the definitive description is a part.

The compact notation of FIGS. 1 through 5 may be abstracted from an existing system consisting of digital, analog, and hybrid analog-digital circuits and collections of circuits, e.g., via an ATE apparatus employing the compact notation. The apparatus of FIGS. 1 through 5 may be illustrative of interconnected (things) that may share [places], e.g., for input and output. The (things) may share {paths} that connect [places] directionally from an input or source to an output or sink. The [places] may participate in /actions\ that may be initiated, terminated, or modulated by <causes> realized in such apparatus and noted within the memory of such apparatus with computing of improved security such that the apparatus may have consistent self-referential self-awareness. The compact notation may be employed as a compact notation for functions often realized in, e.g., a special purpose digital hardware apparatus and often realized using both special purpose data that controls general purpose digital hardware. Such data may be referred to by those skilled in the art as software for a general purpose processor, according to the apparatus correspondences shown as an example in Table 1.

TABLE 1
Correspondence Between Hardware and Data Processing Apparatus

| Function | Illustrative Hardware Apparatus | Illustrative Data Apparatus |
|---|---|---|
| (thing) | (signal) (device) (chip) (board) | (data) (operation) (module) (program) |
| [place] | [Input Connector] [Output] | [Input parameter] [Output] |
| {path} | {[Input](device1)(device2) [Output]} | {[Input](module1)(module2)[Output]} |
| /action\ | /(chip) processes (signal)\ | /(program) processes (data)\ |
| <cause> | <initiate/(chip)processes(signal)\> | <evaluate/(program)process(data)\> |

According to aspects of embodiments of the disclosed subject matter data a apparatus illustrated may comprise a hardware-dependent coded form of data. Data coding can be understood by those skilled in various arts of information theory and processing theory, coding theory, and communications theory. Data encryption known to those skilled in the art may include adding a stream of random bits r to a string of intelligible bits b via an exclusive OR operation (⊕) to yield a string of encrypted bits e=r⊕b. A memory based transform (“MBT”) storage, such as, into a memory m of bits b may represent the instructions of an ISA itself. The instructions may, e.g., represent sequences of instructions such as for system control or for an application, or may represent data to be operated on or used in control of an apparatus or in the transformation of data according to the needs of an application.

The '835 application discloses the addition into the memory m of the memory based transformation (“MBT”) apparatus of random bits r, e.g., from a source within the processing element of the apparatus of the improved secure system (S). The system (S) may be defined to itself as comprising system S=(S(O(C(P)))) where O may include one or more overlays, C may include one or more cells, and P may include one or more processing cells. Such random bits r may be dependent on the hardware of the apparatus (S), e.g., forming a random bit stream rh=(System (Overlay (Cell (Processing Element (random(t, seed)))), where rh depends on the hardware of a system, on the hardware of an overlay of such a system, on the hardware of a cell of such an overlay, and on the hardware of a processing element of such a cell. It may depend as well as on time t. It may also depend on a known seed that may determine a pseudo-random value rh, which is the type of randomized numerical value that may be generated by a computing procedure with inputs t and seed. The random bit stream rh may be replicated elsewhere using the same procedure with the same inputs t and seed as will be understood by those skilled in the art. In such a case, the seed may depend on S, O, C, and P in a way that may not be linear and that may be difficult for a third party to infer.

According to aspects of embodiments of the disclosed subject matter, such a random bit stream rh may be formed during a process of fabricating a specific processing element of an apparatus S(O(C(P))) and thus rh may be added via an exclusive OR process to any or all definitive descriptions, compact notations, ISA-defining data of a memory based transform, instructions comprising applications, control data, applications data, and to any other form of data bits b, thus forming e=rh⊕b the encrypted form of definitive descriptions, compact notations, ISA, the applications instructions, and the control and applications data of the specific computing and communications system (S).

During manufacture, encrypted or otherwise hardware-dependent data e may be stored into the hardware apparatus, such as in a memory of an associated processing element based on which rh was generated in the factory. this may render b not readily intelligible to a third party and not readily useful until upon initiation, when, e.g., a processing element P may generate rh of necessity of its initialization. Bits rh in an exclusive OR to its own (e.g. non-volatile) memory may be generated, e.g., containing e such that e⊕rh=b. The processing element P may then employ data bits b as intended.

According to aspects of embodiments of the disclosed subject matter, such a randomized memory e may remain randomized in memory m and may be transformed only upon, e.g., transition from memory m of processing element P at time t when seed S is provided to that processing element P by communications disclosed, e.g., as discussed in the '835 application. Consequently, processing elements external to P may employ data bits b for purposes consistent with the definitive description of system S constructed according to FIGS. 1 through 5 above and of the '835 application and as further disclosed below.

According to aspects of embodiments of the disclosed subject matter, hardware-dependent data may be constructed in a manner that is hardware-dependent as contemplated in the '835 application, and as discussed here, to yield an apparatus consisting of hardware and hardware-dependent data embedded into that hardware apparatus. The apparatus may be, e.g., non-volatile memory or include the distribution of data by communications among the processing elements, cells, and overlays of such an improved secure system. The system may also include, e.g., cells that may be proximate to each other and cells that may be remote, e.g., connected via potentially intermittent improved secure communications paths as mentioned in the of the '835 application. As an example, FIG. 5 shows the method of behavioral notation and exemplary apparatus for a <hardware cause>, to with <an exemplary control signal 501> that initiates or inhibits the operation of {an exemplary signal processing path 502}. To summarize, in FIG. 5 is shown an illustrative design notation for control of hardware. A clock pulse at <501 control> can initiate initiates or inhibits the signal processing flow through the {signal processing path 502} of the illustrative filter circuit. The clock pulse <501 control> can then have the role of a <Cause> over {path 502} of the illustrated example of a digital filter circuit. The explicit delineation of <cause 501> over {path 502} can be represented to the system itself by a compact definitive description <501 {502}> or equivalently as <control {([Input] digital filter circuit [Output])}>.

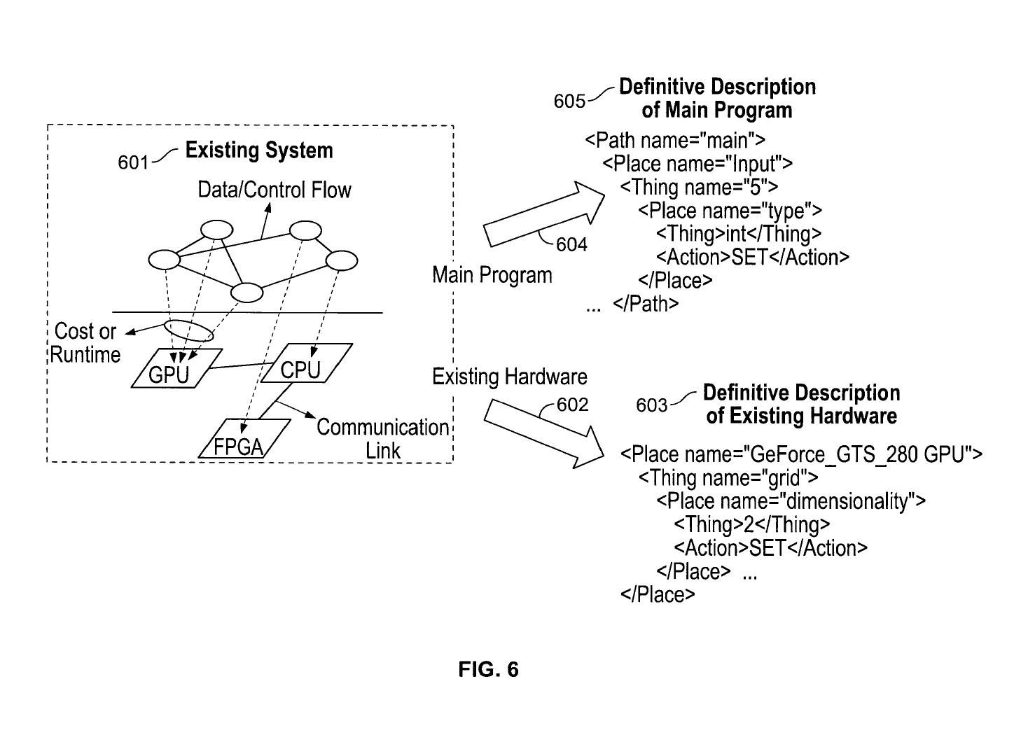

According to aspects of embodiments of the disclosed subject matter, FIG. 6 shows the operation of an exemplary an automatic analytic apparatus that is configured according to the '835 application and according to the disclosure of FIGS. 1 through 5 above. The apparatus can automatically extract a definitive description from an exemplary existing computing and communications system 601 via the methods and apparatus as shown by way of example in FIGS. 1 through 5. The automatic analytic apparatus may be applied to extract via an exemplary apparatus 602 a definitive description 603 of the exemplary hardware apparatus. The description may comprising a subset of an exemplary existing system 601. The exemplary apparatus 602 of the automatic analytic apparatus may comprise an ATE apparatus that is physically attached to the hardware input ports, keyboard ports, network ports, sockets, test ports (e.g. Joint Test Advisory Group (JTAG) ports), output ports and/or other access points of existing system 601.

The automatic analytic apparatus may extract via exemplary apparatus 604 a definitive description 605 of the exemplary data elements of existing system 601. The definitive description may include, for example, functions associated in existing systems as device drivers, operating systems, applications, web pages, applets, and graphics display data, that may be referred to by one skilled in the art as software and/or data comprising a hardware-dependent data subset of the exemplary existing system 601. The apparatus 604 may attach to the memory, hard drive, or backup tapes of the existing system 601. The apparatus 604 may extract data from non-persistent or persistent storage via mechanisms that may be understood to one skilled in the art as corresponding a kind of computer forensics.

An apparatus 602 has been realized, by way of example, on a small scale as an example of an ATE that can examine existing hardware design languages, such as a very high speed integrated circuit (“VHSIC”) hardware design language (“VHDL”). An apparatus 604 can be realized on a small scale embedded into an existing system for generating definitive descriptions of modest sized collections of data of the existing system that can, e.g., be formatted in languages that include Matlab, C, C++ and VHDL. The apparatus 604 can access both transient memory and hard drives of existing systems.

An integrated realization, e.g., of a hardware extraction apparatus 602 via changes to ATE hardware and the software extraction apparatus 604 via changes to computer forensics hardware may be realized together in an improved secure computing and communications system as disclosed in the '835 application. Together they may comprise an improved secure automatic analytic apparatus that automatically extracts such definitive descriptions. This can thus reduce the time for transforming an existing system into and improved secure system and eliminate the need for human understanding of the existing system before realizing the improved secure system.

FIG. 6 shows, by way of example, a method of operation of an exemplary apparatus disclosed here for automatically extracting a definitive description from an exemplary existing computing and communications system 601 via the methods and apparatus as shown by way of example, in FIGS. 1-5 as applied for illustrative purposes to extract via exemplary apparatus 602 a definitive description 603 of the exemplary hardware apparatus comprising a subset of the an exemplary existing system 601.

The method of operation of FIG. 6 also shows an example of extracting via exemplary apparatus 604 a definitive description 605 of the exemplary data elements. the exemplary data elements may include device drivers, operating systems, applications, web pages, applets, and graphics display data, usually referred to by one skilled in the art as software and/or data comprising a hardware-dependent data subset of the exemplary existing system 601. An integrated realization of hardware extraction apparatus 602 and software extraction apparatus 604 in an improved secure computing and communications system such as is disclosed in the '835 application together may comprise an analytic apparatus that automatically extracts such definitive data, referred to for purposes of the present application as an automatic analytic apparatus.

### Automatic Definitive Mapping Apparatus

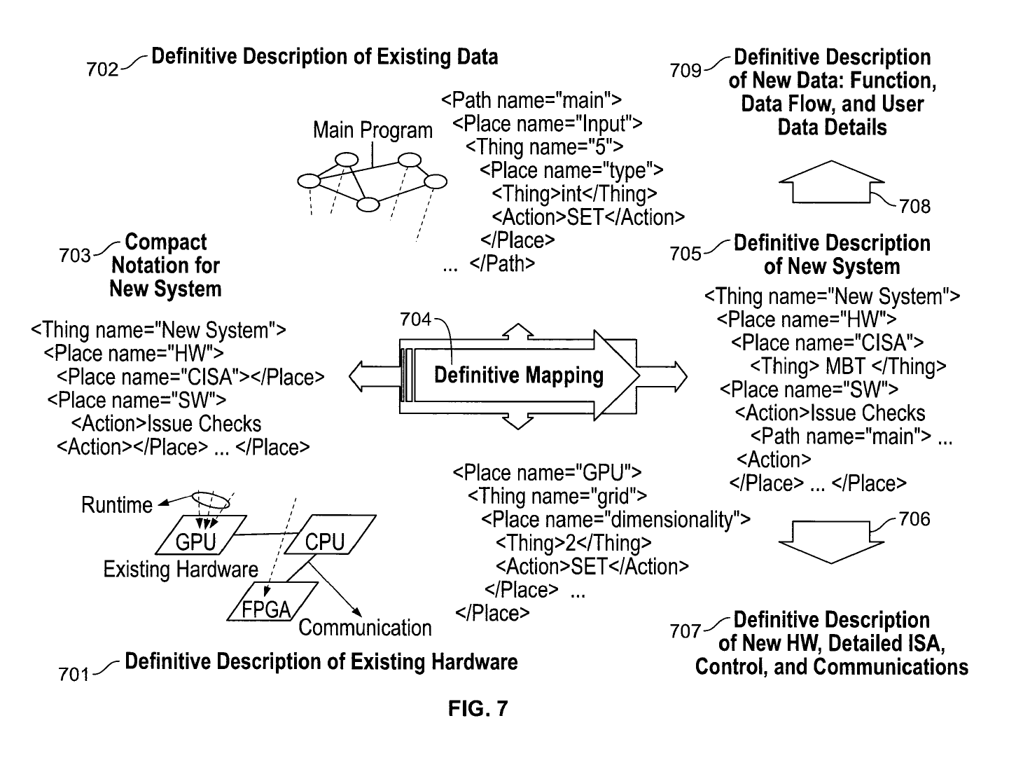

According to aspects of embodiments of the disclosed subject matter, FIG. 7 shows an example of a method of operation of an exemplary apparatus disclosed more fully below as an automatic definitive mapping apparatus that may, e.g., automatically synthesize improved secure hardware 707 and its associated hardware-dependent data elements 709 from a set of, for example, three data elements. The set of three data elements may, e.g., comprise (1) one or more definitive description(s) 701 of existing hardware as may be generated via an automatic analytic apparatus, e.g., as shown in FIG. 6 or otherwise, (2) one or more definitive description(s) 702 of existing data as may be generated via an automatic analytic apparatus such as is shown in FIG. 6 or otherwise; and comprising (3) one or more compact notation(s) 703 of the '835 application Claims 10 and 11 as may be configured for the guidance and control of a definitive mapping apparatus 704 that may result in an improved secure computing and communications system. An automatic definitive mapping apparatus 704 may generate an integrated definitive description 705 of, e.g., an improved secure system. An integrated definitive description may encode in its definitive description 705 a primitive recursive ISA as also discussed in the '835 application. An integrated definitive description may encode in its definitive description 705, e.g., self-referentially consistent data structures.

According to aspects of embodiments of the disclosed subject matter, an improved secure system may be fabricated automatically in a hardware apparatus with hardware-dependent data apparatus such as for example an improved hardware apparatus 707 fabricated automatically according to a hardware realization method and apparatus 706 and comprising further hardware-dependent data 709 of apparatus 707 that causes the improved hardware apparatus 707 to perform computing and communications with improved security.

According to aspects of embodiments of the disclosed subject matter, as illustrated by way of example in FIG. 7, an improved secure system hardware apparatus 707 may be fabricated automatically according to a hardware realization method and apparatus 706 that translates a definitive description into the VHSIC Definition Language (VHDL) that may be known to those skilled in the art of the fabrication of applications specific integrated circuits (ASICs). Applicants have synthesized an initial embodiment of apparatus 706 that can, e.g., translate the compact notation of the '835 application into VHDL code that may be loaded into a conventional field programmable gate array (FPGA) to demonstrate the method of operation of apparatus 706 that may be realized in a suitably configured FPGA, ASIC or other digital hardware.

According to aspects of embodiments of the disclosed subject matter, hardware-dependent data 709 may be generated, e.g., via an automatic data realization method and apparatus 708 that may automatically generate improved secure data 709. The improved secure data that may induce the apparatus 707 to perform computing and communications input, output, and user applications that may be functionality equivalent to computing and communications functions conventionally realized in an existing system E. The improved secure data may allow for distinct and layered hardware, software, firmware, user data, and control data. In such an improved secure system S such hardware-dependent data may be embedded in a parallel and distributed apparatus such as is disclosed in the '835 application so that the improved hardware apparatus may be able may compute and communicate with improved security.

According to aspects of embodiments of the disclosed subject matter, an automatic data realization method and apparatus 708 may automatically generate improved secure data 709. The apparatus 708 may automatically translate a definitive description of an improved secure system S in part into hardware-dependent data that may be installed into a specific hardware apparatus 706 for which it may be configured. Applicants have fabricated an apparatus that transforms a partial definitive description of a typical element of an improved system S from the compact notation of the '835 application into conventional computer languages C, C++, Matlab, and CUDA. The fact that programs in these languages can comprise formatted data of a complex but specified format, such a realization of a translation from compact notation itself to such conventional computer data formats, with no other additional data and with no human intervention, constitutes a demonstration that the compact notation is sufficient to represent all of the computational behaviors, inputs, outputs, and processing in the form of (thing), [place]. {path}, /action\, and <cause>.

FIG. 7 shows, by way of example, a method of operation of an exemplary apparatus, according to the disclosed subject matter, that automatically synthesizes improved secure hardware 707. Associated hardware-dependent data elements 709 from the set of three data elements comprising can be synthesized. Such may include, as noted above (1) definitive descriptions 701 of existing hardware, (2) definitive descriptions 702 of existing data and (3) compact notation 703 of the '835 application configured for the guidance and control of a definitive mapping apparatus 704. The result can allow for an improved secure computing and communications system.

The automatic definitive mapping apparatus 704 may generate an integrated definitive description 705 of an improved secure system that can, e.g., encode in its definitive description 705 a primitive recursive ISA applicable over the self-referentially consistent data structures of the '835 application. The improved secure system may be fabricated automatically in hardware and hardware-dependent data components, such as, an improved hardware apparatus 707 fabricated automatically according to a hardware realization method and apparatus 706. The apparatus 707 may comprise further the data 709 of apparatus 707 that causes the improved hardware apparatus 707 to perform specified functions with improved security. The data 709 may be generated automatically via an automatic data realization method and apparatus 708. The apparatus 708 may generating the improved data 709 so as to include functionality equivalent to that conventionally realized in distinct and layered software, firmware, user data, and control data. The data 709 may be used in the improved secure system according, e.g., as embedded in parallel and distributed apparatus. Thus, the improved hardware apparatus can be made able to compute and to communicate with improved security.

### Improved Secure Instruction Set Architecture (ISA) Apparatus Mapping

According to aspects of embodiments of the disclosed subject matter, a finite ordered sequence of fewer than N [symbol] N max compact notations may be a compact notation which for purposes of the present application is referred to as a clause, a sentence, or an expression utilizing the compact notation. There may be a mapping between a definitive description comprised of phrases in a compact notation and hardware elements of an apparatus comprising an improved secure ISA. Hardware elements of such an apparatus may be conventional off the shelf (COTS) items such as power supplies or memory chips or hardware elements. Alternatively such an apparatus may be uniquely designed and implemented for improved security.

Such a mapping between notation and hardware may comprise aspects of an improved secure ISA such as autonomous classes of instruction denoted verbosely as /autonomous\ actions and denoted compactly, e.g., as an ISA class /a\ mapped to an improved secure apparatus (S) and its hardware-dependent data d. The class /a\ may be mapped with the actions /a\ such that (S) may, e.g., remain consistent with the definitive description of (S) “DDS”. Embedded into (S), e.g., as hardware-dependent data with hardware realizing an apparatus of autonomous classes of instruction, a DDS may realize a comprehensive organization plan (COP) for (S). In addition S may be assured to conform consistently to the COP of the DDS in its associated apparatus.

Such a mapping may comprise aspects of autonomous classes of instruction that may include a built-in tamper-detection class of instruction. Such a temper-detection class of instruction may be, e.g., denoted verbosely as /tamper detection\ and denoted compactly as ISA class /td\. The class of instruction may be mapped to multiple COTS or system-specific physical, mechanical, and electromagnetic sensors to detect tampering. Such may include the attachment of devices, removal of screws, removal of grounding, removal of a mechanical cover, etc. of an improved secure apparatus (S), e.g., as discussed in the '835 application.

Instructions of the class /td\ may invoke themselves regularly at specific or at randomized time intervals or in conjunction with other actions of apparatus (S) to, e.g., autonomously and irrevocably test for tamper detection. The instructions may also perform related actions autonomously should there be evidence of tampering occurring or having occurred. Although it may be possible for a malicious agent to physically intrude into the physical space of an apparatus (S), for example, in order to deny service, an improved secure apparatus S and its hardware dependent data may be configured so that it is not possible to change a /td\ instruction. The apparatus (S) autonomous behaviors and randomized and obfuscated self-preserving responses remotely and/or without multi-factor multi-human authorization attested by sensors of the apparatus (S) and with attested multi-human oversight for the duration of such amended tamper-related behavior result in successful defense against tampering.

Such a mapping may comprise aspects of autonomous classes of instructions that may include an electric power monitor class of instruction. The electric power monitoring class of instruction may be denoted verbosely as /power monitoring\ and denoted compactly as ISA class /pm\. It may be mapped to multiple COTS or system-specific electromagnetic sensors of an improved secure apparatus (S). The /pm\ class may contribute information regarding the state of the self (S) to /td\.

Such a mapping may comprise aspects of autonomous classes of instruction that may include a temperature monitor class of instruction denoted verbosely as /thermal monitoring\ and denoted compactly as ISA class /th\. The /th\ class may be mapped to multiple COTS or system-specific physical and thermal sensors of an improved secure apparatus (S). The /th\ class may contribute information regarding the state of the self (S) to /td\.

Such a mapping may comprise aspects of autonomous classes of instructions that may include an audio monitor class of instruction denoted verbosely as /microphone\ and denoted compactly as ISA class /mic\. The /mic\ class may be mapped to multiple COTS or system-specific audio sensors of an improved secure apparatus (S). The /mic\ class may contribute information regarding the state of the self (S) to /td\.

Such a mapping may comprise aspects of autonomous classes of instructions that may include a video monitor class of instruction denoted verbosely as /video\ and denoted compactly as ISA class /v\. The class /v\ may be mapped to multiple COTS or system-specific cameras or other sensors of an improved secure apparatus S. The /v\ class may contribute information regarding the state of the self S to /td\.

Such a mapping may comprise aspects of autonomous classes of instructions that may include a signal generation class of instruction denoted verbosely as /signal generation\ and denoted compactly as ISA class /sg\. The class /sg\ may be mapped to multiple COTS or system-specific pseudo-noise (PN) sequence generators, e.g. with reference to an integrated circuit chip's own embedded random signature of an improved secure apparatus (S). The /sg\ class may contribute information regarding the state of the self S to /td\.

Every chip in the hardware apparatus of an improved secure system (S) may share a large number of embedded random signature bits with every other chip in the system (S). Each chip in the system (S) also may have some unique signature bits. The /sg\ instruction class may employ a method of generating PN sequences as quasi-synchronous bit streams allowing for timing jitter among PN sequences. As /sg\ may specify in the definitive description of an improved secure system (S), the apparatus of each chip, PE, module, board, enclosure, rack, and system shall generate PN sequences with related mathematical properties. From the PN sequences hardware-dependent data may be generated, protected, and destroyed by the interplay among such sequences.

Signal generation instructions /sg\ can be used, e.g., to constantly monitor all other instructions and may parasitically modulate PN signals generated according to the class of instruction(s) being executed or according to the parameters of those instructions. Parasitic modulation may distribute onto a reference bit stream a small number of bits, Nib, at a low data rate, Rib, such that Nib's generate correctable single-bit errors that are corrected by receiving PEs and are observed and verified by attestation PEs to confirm the validity of the source bit stream as a part of the self (S). The error residuals are analyzed by the attestation PEs thereby may observe, trace, and validate that the behaviors of PEs to conform to the COP. Non-conforming PEs may be reported from, e.g., an IP cell to an IP overlay and may be quarantined, suspended, scrambled, or killed depending on the severity of the non-conformance and on the parameters defined by the COP, as is explained in more detail in the '835 application.

Such a mapping may comprise aspects of autonomous classes of instruction that may include a time synchronization class of instruction denoted verbosely as /timing\ and denoted compactly as ISA class /t\. The class /t\ may be mapped to multiple COTS or system-specific clocks or frequency standards of an improved secure apparatus (S). The /t\ class may contribute information regarding the state of the self (S) to /td\. The class /t\of the COP can be used, e.g., to specify that the corresponding hardware apparatus of the improved secure system (S) searches for and obtains time synchronization among plesiochronous PN streams impinging on a PE. The class /t\ may measure time delay in integer bits from an internal master PN, e.g., for associated correlators. The term Plesiochronous is derived from the Greek plesio, meaning near, and chronos, time, and refers to the fact that commercial plesiochronous systems run in a state where different parts of the system are almost, but not quite perfectly, synchronized, achieving perfect synchronization only when and where needed, such as within cross-correlation processes of hardware processors as more fully disclosed in the '835 application, and allowing asynchronous operation otherwise, such as in moving data from one processor to another via a cell membrane as more fully disclosed in the 835 application.

Such a mapping may comprise aspects of autonomous classes of instruction that may include a correlation class of instruction denoted verbosely as /correlation\ and denoted compactly as ISA class /c\. The class /c\ may be mapped to multiple COTS or system-specific correlation circuits of an improved secure apparatus S. The class /c\ may measure the correlation between an internally generated master PN sequence and other PN sequences. The /c\ class may operate in two phases, e.g., synchronization and validation. The synchronization phase may last for a relatively small number of bits required to search for and obtain full or essentially complete correlation. The bits to be matched by a correlation operation in a correlation apparatus need not be contiguous but may be distributed throughout a finite extent of the observed bit stream. They may also be matched to the master PN bit-by-bit or in a distributed non-contiguous format, depending on instruction parameters. For example, if 1000 bits were to match exactly, the degree of correlation would be 1000, while if the bits differ in 500 places, then the degree of correlation is 500.

The number of bits to correlate between the master and independent bit streams may be a parameter setting of class /c\. Each correlation channel may employ offsets, masks, and other correlation devices known in the art. A COP notation /c\ may specify a minimum number of correlators in the hardware apparatus that must correlate to a given degree simultaneously and in synchronism, in order for a PE to contribute to an IPcell. For example, a minimum of three correlators plus the generator of a PE may cross-check with robustness, such as via majority logic adjudication of temporary inconsistencies induced, e.g. during startup phases and transient anomalies.

According to aspects of embodiments of the disclosed subject matter, an IPcell may embed an entire COP as hardware-dependent data from which it may, e.g., derive the parameters of the /autonomous\ actions that the IP cell may apply locally within the IP cell and between IP cells according to the placement of the IP cell's hardware within the improved secure apparatus (S).

Such a mapping may comprise aspects of an improved secure ISA such as discretionary instruction classes verbosely noted as /discretionary\ actions and compactly noted as class /d\. The instruction class /d\ may be provided in the definitive description to specify applications-oriented behavior of an improved secure system. Such a mapping may comprise aspects of a discretionary instruction class that defines the physical scope in the hardware of (things) of the definitive description, verbosely noted as /scope definition\ actions and compactly noted as class /sd\. The scope definition class /sd\ may be mapped to specified subsets of the hardware apparatus and associated hardware-dependent data of an improved secure system. An /sd\ class may name a (thing) and may define the physical extent in the apparatus itself of such a named (thing). For example the named (thing) may be indicated to be extant in specified hardware items, between limits within a hardware item, or in a random position in a pre-defined or derived domain. An associated /link\ instruction may associate named (things) with each other by establishing physical mappings, e.g. between a reference (thing) in hardware and its associated [places] in the hardware. An action /link A B\ may define a path {A B} that may be followed physically such as via an electrical circuit or fiber optic link by a PE, IP cell, or IP overlay.

Such a mapping may comprise aspects of a discretionary instruction class that may define hardware-dependent (data things), verbosely noted as /define\ actions and compactly noted as /def\. The /def\ actions may be mapped to specified subsets of the hardware apparatus and associated hardware-dependent data of an improved secure system. A /def\ action may define a primitive domain that may be pre-defined to include an (abstract data thing). The (abstract data thing) may be a (thing) of (physical [scope]) that may be Nil, the empty set.

The /def\ action may define a primitive domain that may be pre-defined to include another (abstract data thing). This (abstract data thing) may be Nmax, the largest practical integer that, e.g., may be expressed given the memory size of the improved secure system (S) itself. Such an Nmax size may establish the finiteness of a primitive domain. The /def\ action may define another (abstract data thing). This (abstract data thing) may be a primitive domain constraint N<<Nmax. Such a domain constraint may require N<<Nmax, so as to, e.g., assure that the parameter N that defines the scope of a primitive domain cannot consume resources to defeat protection of the self (S). Nmax may be defined for each level of an improved secure system (S), per PE as (Nmax), per IP cell as (IPcell(Nmax)), per IP overlay and otherwise.

A /def\ action may define another (abstract data thing), which may be, e.g., a (Binary Digit)===(Binary [0]) through (Binary [1]), a digit having two states 0 and 1; and its associated simple derived domains (Binary*N), (Octal Digit), (Integer Digit), and (Hexadecimal Digit). (Binary*N)===(Binary*N [0 . . . 0]) through (Binary*N [1 . . . 1]) of N binary digits, N)) Nmax. *N can be a physically bounded star operator that can be used to indicate that there will be one or more but not greater than N of the (things) immediately preceding the star *N. A /def\ action may define another (abstract data thing) that may be (Binary) then (Binary*N) and ((Binary)*N) may be identical.

A /def\ action may define another (abstract data thing), which may be (Octal Digit)===(Octal [0]) through (Octal [7]), having eight states 0 through 7. This may be denoted as (Octal*N). A /de action may define another (abstract data thing), which may be (Integer Digit)===(Integer [1]) through (Integer [9], with (Integer*N), N)) Nmax. A /def\ action may define another (abstract data thing), which may be (Hexadecimal Digit)===(Hexadecimal [A]) through (Hexadecimal [F]), with (Hex*N). A /def\ action may define another (abstract data thing), which may be (Zero)===0, the unique symbol representing the additive identity.

A /def\ action may define another (abstract data thing), which may be (TRUE)===in a (Binary) domain, tantamount to, i.e., identically equivalent to, 1, but TRUE may not be defined in any other domains, and in particular may not be valid as the value of an (Expression). A /def\ action may define another (abstract data thing), which may be (FALSE)===in a (Binary) domain, tantamount to, i.e., identically equivalent to, 0, but FALSE may not be defined in any other domains, and in particular may not be valid as the value of an (Expression). A /def\ action may define another (abstract data thing), which may be (Binary Logic), and, e.g., may admit only the things (TRUE) or (FALSE) in its [Value] place.

A /def\ action may define another (abstract data thing), which may be (Sign)===(Sign[+]) or (Sign[−]), where unsigned numbers may be interpreted as either + or −. A /def\ action may define another (abstract data thing), which may be (Exponent (Base))===the log of a number with respect to the Base, provided, e.g., the residual of which is termed a (Mantissa). Typically Base for a log may be 2, e, or 10, but the (Exponent) domain may be defined with respect to some other base. A /def\ action may define another (abstract data thing), which may be (Floating Point Number)===(FPN (Sign) (Mantissa) (Exponent (Base))), e.g., in IEEE format known to those skilled in the art. A /def\ action may define another (abstract data thing), which may be (Rational Number)—(Rational (Integer numerator) (Integer denominator>>0). A /def\ action may define an (abstract data thing), which may be (Infinity)===INF, the unique symbol representing the inability to count that high and the value of a Rational Number when the denominator is zero.

A /def\ action may define another (abstract data thing), which may be (Undefined)===UNK, the unique symbol representing the lack of definition of an expression. A /def\ action may define another (abstract data thing), which may be (Character)===(Character[000]) through (Character[127]), which may be the ASCII characters, while (Character[64 k]) may define 16 bit Unicode, and (Char*N) for N<Nmax may define strings of exactly N characters. A /def\ action may define another (abstract data thing), which may be (String)===(String [(′) [(Char*N)] (′)]), which may define a string constant of length N.

A /def\ action may define another (abstract data thing), which may be (Nil), i.e., nothing, i.e., the unique symbol representing the empty set. A /def\ action may define another (abstract data thing) that may be (Expression), e.g., something to be evaluated. (Expression) may be the only primitive composite domain defined, a (Domain) whose domain is not itself, but is derived from the domains of its constituents. (String) may be a valid domain for (Expressions). An (Expression) may be evaluated by multiple PEs, one performing sequential sub-expression evaluation (e.g. left to right evaluation of a string), broadcasting to adjacent attestation PEs its sequential operations and states. The attestation PEs may estimate space-time per sub-expression and may detect resource usage, space leakages, etc. that are not in conformance with the COP, quarantining the PE upon detection of such violations via a (Not Verifiable) fault. Expressions may be assessed before evaluation for validity by multiple PEs to check each other to detect the induction of infinite verification loops, validation resource explosion, and other such denial of service behavior of the core PEs and to suppress such behavior.

A /def\ action may define an (abstract data thing) that may be (Safe). A (safe thing) may include an expression consisting of a sequence of primitive operations on primitive and validated derived domains that conform to constraints expressed in the COP. Sequences of primitive operations on primitive and validated derived domains that conform to constraints expressed in the COP may be classified as (Safe). Only (Safe (Expressions)) may be evaluated.

A /def\ action may define another (abstract data thing) that may be (Verifiable)===V, comparable to what may be an ambiguous or misleading value TRUE of Boolean logic. If the (Self) has a mechanism for deriving an answer, but the answer either does not conform to the domain template, e.g. /def\, for the answer or cannot be derived within the sources provided, the finite response may be (NV), not verifiable. So in evaluating the (Expression) (“1+1=‘2”’)), the (String(2)) does not conform to the units requirement of the equal sign that sets up the expectation of (Number(2)), and if the (Self) has an ability to /convert(String[value(s)]) to (Number([values])\, then the value of (Expression) may be (V), which autonomously may raises a (V) exception by which the system may propose to three or more authorized human beings or to authorized components of the self, (S), to endorse the system's plan to apply the /convert\ action. The (self) thus may learn to apply the /convert\ action autonomously whenever number-string conversion is required and is not inconsistent with the COP in the future. For example, if human beings authorize /convert(String[value(s)]) to (Number([values])\ for the (Expression) (“1+1=‘2”’)), then the (self) may note in the COP that <(humans(person1)(person2)(person3)/convert (String[value(‘2’ [(Expression) (“1+1=‘2”’))]])]) to (Number([value (2)])\>, i.e., informally that three persons authorized the conversion of a string ‘2’ to a number, and that these 3 people had indicated that this example applies to any such strings and numbers, provided that the resulting number is in the required domain (e.g. 0<Number<40 for the domain (regular hours per week on a time card)).

A /def\ action may define another (abstract data thing) that may be (Not Verifiable)===NV. For example, it would take 100 years to solve a traveling salesman problem with 1000 cities exactly, but an approximation could be generated, say using a heuristic hTSP(cities)=route in, say 1 second. If the (self) knows that hTSP for 1000 cities is not guaranteed to be exact, the (self) may /define\ route as (NV) because it would take 100 years to verify that the route is correct. The action /def (NV hTSP( ))\ defines any answer from the operation hTSP to be not verifiable so that the value route from hTSP would be (NV route) such as (NV (route [3, 212, 911, . . . ])), where the list indicates to travel first to city 3, then to city 212, etc. This /def\ action is comparable to the ambiguous and misleading types of things, such as /def (ambiguous fruit)\ where /def (fruit (apples) (oranges))\ because the thing fruit consists of two different kinds of things, apples and oranges. The /def\ action /def (misleading ‘This sentence is false’)\ associates the type of thing (misleading) to the self-referentially inconsistent sentence because if it is true, then it must be false, so it can have no self-referentially consistent Boolean truth value. Within a Boolean system, the tag (inconsistent) may be used, while for a user interface, the tag (misleading) may be more helpful, leading to the more complete compact notation /def (misleading [Boolean (inconsistent ‘This sentence is false’)])\ which establishes that the sentence may be tagged as misleading and in addition, in the [domain Boolean] which is a place, also is inconsistent.

A /def\ action may define another (abstract data thing) that may be FALSE in binary logic. When the (Self) evaluates expressions and a mule PE or pit bull PE, as defined in the '835 application, determines that the answer cannot be derived within the resources expected, the finite response of the (self) is that the expression is not verifiable (NV) and an (NV) result may initiate a fault autonomously logged and acted upon. Reasoning produces either verifiable results (V) on the one hand or on the other hand (NV), which is both not TRUE and not FALSE at once. For example, expressions like (Expression2 (“This sentence is false)) may loop forever under binary truth values, whereas in the ISC2 ISA, hardware that evaluates Expression2, e.g., compactly noted as /Eval(Expression2)\ employs the function of a loop detector inherent in the self-resource monitoring of each cell of the improved secure architecture of the '835 application to yield the result (NV) and to report the detection of an infinite loop (INF) via the (NV(INF)) fault. A /def\ action may define another (abstract data thing) that may be (Ambiguous), e.g. when an expression may be both V and NV in different circumstances.

A /def\ action may define an (abstract data thing) that may be (Uncertain)===(?) or(Unknown)===UNK when an expression has yet to be evaluated to some specific value. For example the function to get the next message from a communications port get(M) may be known to the (self) as (UNK (get (M))) when there is not yet a message M. The message M may be reasoned about as (UNK M) without self-referential inconsistency, for example in determining whether to wait for M or not.

A /def\ action may define another (abstract data thing) that may be (Randomized (thing) (method (seed)))—a (thing) that has been randomized, e.g., using a specified (method) initialized with the specified (seed). A (Randomized (thing)) that may not specify the method for randomization may be randomized or encrypted via a method defined external to the (Self).

A /def\ action may define another (abstract data thing) that may be (Random), which is an element of data in a domain X that is maintained in a random state by regularly writing random bits over the domain X. The randomization rate may be the inverse of the time between randomizations, i.e., T random.

A /def\ action may define another (abstract data thing) that may be (Data Block) or (DB), which is a collection of related data elements from any or all of the domains listed above. A mechanism for integrating elements may include concatenation, padding, randomization, row-column interleaving, random interleaving, and other methods composed by combining defined (abstract data things) together according to a need, such as to form a database schema.

A /def\ action may define another (abstract data thing) that may be (Signature), which may be a random string of N binary integers or a random analog sequence, such as from an analog noise source. A /def\ action may define another (abstract data thing) that may be (EQUAL) if and only if two specified members of a primitive domain are identical. For example, the compact notation [Numbers (EQUAL (1+1)(2))] expresses that in the domain of the natural Numbers, the anonymous thing(1+1) which is a numerical expression and the number (2) which stands for itself are equal.

A /def\ action may define another (abstract data thing) that may be (UNEQUAL) where two members of a primitive domain may be not identical. For example, although [Numbers (EQUAL (1+1)(2))], in the domain (strings), the expression [Strings (UNEQUAL (1+1)(2))] may be verified because the string ‘1+1’ is not identical to the string ‘2’. Such compact notations as (EQUAL) and (UNEQUAL) for hardware-dependent data may allow the (self) to remember the results of operations performed previously, such as comparing thing (1+1) with thing (2) in different domains.

According to aspects of embodiments of the disclosed subject matter, (Domains) may be expressed in the COP as (Strings) for explanatory and tutorial purposes, and may be embedded in the (Self), e.g., as (Randomized (String)) recoverable via the (PE (Signature)), using some (method), time, and (seed).

A /def\ action may define another (abstract data thing) that may be (Processor) that may be a collection of physically connected elements that perform processing. A /def\ action may define another (abstract data thing) that may be (Processing Element) or (PE) that may be an element that processes data in its memory based transform. A /def\ action may define another (abstract data thing) that may be (Memory Element) or (ME) that may be an element that may retain data for a specified time when attested via sensors related to /td\ to be a part of the (self) and if not over-written. A /def\ action may define another (abstract data thing) that may be (Interconnect) or (IX) that may be an element that provides data paths between other elements. A /def\ action may define another (abstract data thing) that may be (Sensor) that may be a processor that includes one or more sensing elements. A /def\ action may define another (abstract data thing) that may be (Sensing Element) or (SE) that may be a device that detects via sensors and that characterizes physical phenomena via memory and processing, such as characterizing a visual scene (e.g. via an array of cameras), an acoustic scene (e.g. via an array of microphones), temperature, shock, vibration, power, etc.

A /def\ action may define another (abstract data thing) that may be (Correlator) or (CX) that may be a device that cross-correlates two or more analog or digital signals. A /def\ action may define another (abstract data thing) that may be (Signal Generator) or (SG) that may be a device that generates analog or digital signals via some (/method\) that may be defined internally to the (Self) or externally and may employ some (seed) that may be defined in the (self) or that may be defined externally or procedurally.

A /def\ action may define another (abstract data thing) that may be (Effector) that may be a device that includes processing to perform a physical action. A /def\ action may define another (abstract data thing) that may be (Effector Element) or (EE) that may be an element that effects a physical result, such as lights, displays, acoustic signals (e.g. speaker, voice synthesis, etc.), thermostat, power controls, and robotic manipulation. A /def\ action may define another (abstract data thing) that may be (Power Source) or (PS) that may be a device that provides power to an element. A /def\ action may define another (abstract data thing) that may be (Mule) that may be the domain for performance of actions defined by the ISA.

A /def\ action may define another (abstract data thing) that may be (Pit Bull) that may be the domain for the independent modeling, monitoring, assessment and action taken to assure that associated (Mules) conform to the design principles for improved secure computing and communications, to the ISA and to any additional constraints for consistent self-referentially self-awareness imposed by the COP.

Pre-defined domains defined above may be so indicated for tutorial and explanatory purposes. When embedded in an ISC system, domains may be randomized or encrypted, i.e., not stored in the clear. Randomization, e.g., can be a process of adding a pseudo-noise sequence to data. Encryption, e.g., can be a process of transforming data by a defined cryptographic process that is reversible only via knowledge of the method of generation and, e.g., of a cryptographic key employed to encrypt the data.

A mapping between the compact notation and the apparatus and hardware-dependent data may comprise aspects of an improved secure ISA. For example, domains defined above, e.g., verbosely noted as /logic\ actions and compactly noted as class /Ix\, may be mapped to conventional hardware elements such as corresponding logic gates (e.g. AND, OR, NOT, NOR, NAND, etc.) sequential circuits, or memory elements of such an apparatus. Such a mapping may comprise aspects of memory based transforms (“MBTs”) denoted verbosely as /memory based transform\ and denoted compactly as ISA class /MBT\. The class /MBT\ may be mapped to conventional hardware elements comprising logic gates, sequential circuits, and memory elements of such an apparatus. Such a mapping may comprise aspects of processing elements (PE) of the '835 application mapped to conventional hardware elements such as logic gates, sequential circuits, and memory elements of such an apparatus. Such a mapping may comprise aspects of information processing cells (IPcells) of the '835 application mapped to conventional hardware elements such as logic gates, sequential circuits, and memory elements of such an apparatus.

Such a mapping may comprise aspects of information processing overlays (IPoverlays) of the '835 application mapped to conventional hardware elements such as logic gates, sequential circuits, and memory elements of such an apparatus. Such a mapping may comprise aspects of information sensing of the '835 application mapped to conventional hardware elements such as keyboards, buttons, switches, power line sensors, battery sensors, video cameras, tamper detection circuits, microphones, thermal sensors, conventional fiber optic receivers, conventional radio receivers, and other sensors of such an apparatus.

Such a mapping may comprise aspects of information effectors of the '835 application mapped to conventional hardware elements such as graphics displays, holograms, printers, conventional fiber optic transmitters, radio transmitters, and other information effectors of such an apparatus. Such a mapping may comprise configurations of PEs, IPcells, and IPoverlays comprising systems such that existing conventional hardware elements may be configured into communicating computing systems of improved security of the '835 application. According to aspects of embodiments of the disclosed subject matter, a compact notation, such as that disclosed in the of the '835 application and here may be continued in part to include categories of (things) with associated properties including the Processing Element (PE) thing noted briefly as (PE), corresponding to one or more associated elements of an improved secure computing and communications apparatus.

According to aspects of embodiments of the disclosed subject matter, a compact notation such as is disclosed in the '835 application and here may be continued in part to include categories of (things) embodied into a PE including Sensor Elements briefly noted as (SE), Memory Elements briefly noted as (ME), and associated Effector Elements briefly noted as (EE). These elements may be linked via one or more Interconnection paths briefly noted as {IX}. All of the elements together may operate as expressed in compact notation of the definitive description. All of the elements may perform hardware functions required to realize the intended capabilities of the ISA for improved secure computing and communications. A collection of (SE), (ME), (PE), {IX}, and (EE) that may be electrically and mechanically interconnected in proximity and optimized to perform computing may constitute an Information Processing Cell briefly noted as the (IPcell) thing. The (IPcell) thing may correspond to a delineated set of hardware within an improved secure apparatus.

According to aspects of embodiments of the disclosed subject matter, there may be mutual attestation among hardware elements. The mutual attestation may result from, e.g., hardware-dependent data such as of multiple PEs as disclosed, e.g., in the '835 application. Mutual attestation of PEs may be specified in a definitive description using the compact notation of (thing), [place], {path}, /action\ or <cause> with conventional logic such as OR, AND, NOT, EQUALS (compactly noted as ‘==’) in compact notations such as <cause (NOT Overlay1((PE A)==(PE B)==(PE C))) /Overlay1 kill (PE A, PE B, PE C)\> which compactly indicates that when the values of processing elements A, B, and C are not mutually equal, then the Overlay1 of which they are a part shall terminate those three PEs.

According to aspects of embodiments of the disclosed subject matter, the mutual support may apply to sensing, processing signals, processing data, transforming data from one form to another, producing results, measuring performance, estimating resource(s), and counting resource(s), e.g., using (optionally cryptographically) secure and robust mathematical constructs realized in the hardware of the apparatus and in such hardware-dependent data as may control and enable computing and communications. The hardware apparatus may automatically destroy any and every hardware-dependent data element including data employed for functions comparable to conventional user data, to conventional operating systems, to conventional applications, etc, to the degree that the data lacks sufficient timely independent multi-factor attestation by the system's own definitive description, by hardware elements, and by data elements as disclosed herein.

According to aspects of embodiments of the disclosed subject matter, the hardware apparatus may employ its sensors, communications, and its hardware-dependent data to realize a multi-domain computational awareness of the physical and logical character of the machine itself. Also included may be, e.g., people that may come in contact with the machine such as the owners, users and others. The awareness may be of the hardware apparatus' own physical and logical environment such as its address and its own size, weight, and power consumption. The awareness may also be of, e.g., policies for its own behavior as defined by its definitive description and the people with whom it may interact from time to time.

There may be embedded multiple independent power sources within the hardware apparatus, such as batteries printed on chips with self-awareness sensors, hardware and hardware-dependent data to power the autonomous digestion of unsupported parts of the self, including the entire self. This may occur, e.g., should criteria of the definitive description indicate that self-destruction may be appropriate. There may be a scope instruction /scope (thing) (domain (a) (b))\ that may define the physical extent of a (thing) as extant between the limits [a,b] of a specified hardware domain in an improved secure apparatus. Such a /scope\ action may check that things (a) and (b) exist within the (domain). For example, if the (domain) is a (4 k block of memory), then locations (Hexadecimal [0]) and (Hexadecimal [FFF]) are within (domain), so the instruction: /scope (Memory1) (ME*4 k (Hex [0]) (Hex [FFF]))\ may define Memory1 as the entire range of a 4K bit block of memory.

Such an instruction also may define (Memory1) as a derived domain that consists of those elements of the 4K memory between Hex[0] and Hex[FFF]. Subsequent to the execution of such an instruction, (Memory1) may take on the characteristics of a primitive domain. Derived domains may be simple, e.g., derived directly from primitive domains as in this example, or may be complex. Any derived domain that is not a simple domain may be termed a complex derived domain. The representation of numbers as [places] can be utilized in pre-defined (numerical domain) things.

According to aspects of embodiments of the disclosed subject matter, there may be an action /scope (Number) Nil\ that may defines Number as an abstract (thing). A /scope\ action may define(Number) as a (data thing), while an action to /scope [value] Nil\ may alternatively define a place [value] as an abstract (thing) as a part of the self-model, e.g. of the COP. An action to /link value(Number) [value])\ may establish a [place] called [value] on the (thing) called (Number). In such a case, the {link} between a (Number) and its [value] happens to be named {value} and provides {value (Number) [value]}, which is the {value} path between a (Number) and its [value]. Such a linkage may also define a more compact equivalent expression (Number [value]). The PEs may be made explicitly aware of (Number[value]), while the associated PEs may be made fully aware of the [place] roles of a number and its value, e.g., using the link {value [(Number)] [[value]]}, e.g., with the [place] notations for emphasis. A further action to /link value (Number[value]) (Zero)\ can be utilized to establish, e.g., that the value of a number may be (Zero).

When using a /link\ action, the domain (Number) may then be constructed as a derived domain with a named place [value] that may be filled with a (thing) from any of the primitive domains (Binary), (Octal), (Hex), (Floating Point Number), (Rational Number), (Zero), (Nil), (Infinity), (Verifiable), (NotVerifiable), and (Undefined). All of this may be encapsulated compactly in the COP, e.g., defining (Number) as a derived domain using the following expression: (Number [value (Binary) (Octal) (Hex) (Floating Point Number) (Rational Number) (Zero) (Nil) (Infinity) (Verifiable) (Not Verifiable) (Undefined)])

According to aspects of embodiments of the disclosed subject matter, there may be a thing (Infinity) that may be a (Number[value]) that may also be processed by the system without causing an infinite loop. An attempt to divide by zero may induce infinite looping which may be the basis for self-referential' inconsistency and, therefore, e.g., an (NV) fault which may then induce immediate corrective action. There may be a derived domain (Fault) that may define, e.g., ways in which an attempted /action\ may succeed or may fail. The COP for S may define (Fault (V) (NV) (Nil) (Infinite)(Number) (String) (END)). The fault value (Fault (END)) may indicate the successful completion of a {Block}, and may establish the readiness of a PE or (Self) to, e.g., perform additional work or to go to sleep, etc., as appropriate. Attestation PEs may never sleep completely, even when their assigned PEs are entirely powered down, but rather may maintain vigilance in some form as long as power is available.

According to aspects of embodiments of the disclosed subject matter, there may be a derived domain (Set) as an enumerated collection with an associated index set. All (Sets) may be strictly sub-finite, with (Set[size])==N<Nmax)). All (Sets) may then be defined using /scope\ and /link\ actions defined above, encapsulated briefly in the COP as (Set Set-name (Domain([value (value1)]) (Domain([value (value2)]) . . . (Domain([value (valueN)])). (Set-name[size]) may be N, while defining (Set-name[size]) as (Set-name[length D]) may have units of the (Domain) if all [values] are from a single primitive or simple derived (Domain). However, if multiple domains are included in the (Set), then a (Domain) autonomously ascribed to (Set-name) may include the domain (V).

There may be a derived domain of the distinguished thing (Self) that may consist of all of the hardware, hardware-dependent data, sensors, monitors, interconnections, communications links, power sources, and built-in test equipment that may comprise an integrated computing and communications system machine. The (Self) may consist initially of a definitive description that defines the (Self) that may become embedded into a single IPcell. The definitive description of the (self) then may be expressed as an embedded hardware-dependent COP: (Self (IPcell (COP(Self)) (Other)*N)). Such an expression may indicate that the (Self) may be constructed of an IPcell apparatus in which may be embedded a hardware-dependent COP that may describe the (Self) as well as (other) things such as people that may interact with the (Self). A particular (Self), which may be or may become an aggregate entity, may be defined with respect to some specific (IPcell), in some specific location, which may be a specific, bounded physical entity. The physical bounds of the IPcell may be defined by a /def(thing)\ action.

According to aspects of embodiments of the disclosed subject matter, an IPcell may be a collection of specific physical things comprising a hardware apparatus, while the COP may be a collection of hardware-dependent data expressions, so there may be no ambiguity between the COP as a model of the (Self) and the improved secure (Self) S which consists of the apparatus and its hardware-dependent data. Wherever there is a (Self), there may be an IPoverlay that performs (Self-control). This arrangement of this disclosure can then form a consistent self-referential self-awareness mechanism for the (Self). There may be a process of moving the boundaries of the (Self) that may entail integrating additional hardware including PE, M, S, and IX into the (Self). This integration of the hardware may occur by a mechanical process of identifying the new element E, isolating it, digesting it, and assimilating it by moving hardware-dependent data to the new hardware and testing its conformance to the COP. This may then be followed by the expansion of boundaries of the (Self) in the COP to include the new hardware element(s).

It will be understood by those in the art that an instruction set architecture may comprise organizing at least one data thing into a processing path to be acted upon by an action according to a cause. The instruction set architecture may comprise defining a processing element as comprising an input interface configured to receive a data thing into the processing path; a processor in the processing path configured to perform the action on the data thing; and an output interface configured to receive a result of performing of the action on the data thing configured to provide the result as an output of the processing element.

A system may be specified in compact notation, the comprehensive expression of which is a definitive description. A system may comprise an apparatus and method that automatically abstracts beneficial aspects of an existing system for use in an improved secure system. A system may comprise an apparatus and method that automatically generates data defining hardware and hardware-dependent data of an improved secure system apparatus. The system may comprise an apparatus consisting of hardware and hardware-dependent data that includes the definitive description as well as autonomous automatic aspects of the hardware continually assuring that the system behavior conforms to the definitive description in all of its elements with mutual attestation among elements and with an ability to correct and to extend itself according to its own hardware-dependent definitive description embedded therein.

It will further be understood by those in the art that the disclosed subject matter is distinguished from existing computing and communications systems which are based on layering where there is a hardware platform with a central processing unit (CPU), possibly co-processors such as a graphics processor unit (GPU), and associated input-output ports. The CPU accesses main memory containing software instructions and data, typically loaded from a hard drive, optionally with cache memory, all of which are illustrated on the left side of FIG. 6.

The improved secure computing and communications (ISC2) of the 835 application and the present application does not use a single CPU or even a few CPUs and GPUs, but is based on massively parallel processing elements (PE), each with associated memory, e.g. the memory based transform (MBT) of the 835 application. The ISC2 hardware employs no hard drive but instead distributes gigabytes to terabytes of memory to 10's of thousands to millions of PEs. Collections of PE's with associated memory, communications, and mutual-support are called information processing cells (IPcells).

There are no device drivers, no operating systems, no protocol stacks, no applications, but instead, as disclosed in the 835 application, the ISC2 hardware employs hardware-dependent data that achieves the functions of control, data processing, and communications via data representing (things), [places], {paths}, /actions\ and <causes> that informally is understood as the system's DNA, its definition of itself, and more formally is disclosed as the comprehensive operating plan (COP). It is possible to design and build an ISC2 system from scratch, but it may be more cost-effective to transform an existing system into an ISC2 system.

The method and apparatus for transforming existing analog and/or digital components (such as logic gates), existing hardware or software modules (such as device drivers, data bases, email services, etc) or an entire existing system of layered hardware and software into an ISC2 collection of cooperating IPcells that may be organized into IPoverlays of the 835 application is the subject of the current patent application. FIGS. 1-5 show how existing analog and digital hardware may be represented in the compact notation of the 835 disclosure of hardware (things), [places], {paths}, /actions\, and <causes>.

There is no COP for an existing system since existing systems are layered von Neuman architectures and as Turing-equivalent computing (TEC) machines are self-referentially inconsistent. The Table I of this disclosure shows that for each hardware realization of digital logic, there may be a software realization of the identical logic function using general purpose hardware such as a general purpose processor (GPP) like the Intel chip with its registers, complex instruction set chip, cache memory, main memory, hard drive, and input/output ports as well as software for system control and with function-specific software. The software things parallel to the hardware things are (data) and (instructions) that move among [registers], [IO ports] and [memory] as the (GPP)/processes (data) and (instructions)\.

Note the use of compact notation for (things), [places], {paths}, /actions\, and <causes> in this explanation. In such a conventional system, sequences of instructions define {paths} such as {from (a local keyboard) to /network access\ to /web services\, back via /network access\ to (the local display)}. Source code and object code may be analyzed for such paths. During /data processing\ actions, the (values) of [variables] such as keystrokes enable <decisions> to choose one {software path} or {another}<based on those (values)> such as <selecting an {overtime processing routine} when (hours per week) is greater than 40>. Although conventionally thought of as software on a GPP, such {payroll processing functions} may be realized in applications specific hardware (which may be impractical) or in a massively parallel self-checking improved secure computing and communications system of the '835 application.

Conventional digital hardware such as NAND gates may be organized into function-specific blocks such as {adder} that performs the action of adding [two input numbers] to produce [a sum as output], compactly noted as {adder /add [addend1]+[addend2]=[sum]\} for a relatively large collection of cross-coupled NAND gates (as a flip flop for memory), registers (collections of flip flops), and sequential logic (e.g. between registers) to produce the sum in an [output register]. A software action that invokes such hardware also may be compactly noted as {addition /add [addend1]+[addend2]=[sum]\} in a named path or more commonly as an anonymous path {/add [addend1]+[addend2]=[sum]\}, where the action of addition is the placement of values into the variable places [addend1] and [addend2], initiating the /add\ action and obtaining the (value of the sum) in the output place [sum].

The present disclosure exploits the functional equivalence of digital logic whether realized in hardware or software to define a new machine consisting of hardware according to the '835 application and more particularly according to FIGS. 1-5 with which may be associated hardware-dependent data, such as annual salary that has been encrypted by adding random bits in exclusive OR (XOR) to (the salary of a person named joe) so that it may be decrypted only by a specific set of PEs of an IPcell for (the person named joe). In a conventional computing and communications system, the salary of a person named joe is generated dynamically from a database in a hard drive that is specifically designed to work with any hardware. The ISC2 architecture and implementation of FIGS. 1-5 and FIG. 6 and FIG. 7 renders this impossible as explained in the present application.

FIG. 6 shows the extraction of the compact notation from an existing system. If an existing system includes NAND gates, then the notation of FIGS. 1-5 shows how to describe the existing gates as hardware (things), [places], {paths}, /actions\, and <causes>. For a system of practical size, there are millions of such gates and therefor there are hundreds of millions of characters of text notation in the description of such an existing hardware system, the first few lines of which description are shown as 603, the definitive description (DD) of the existing hardware. Automatic test equipment (ATE) may include a stand-alone apparatus that accesses test ports (e.g. JTAG, known to one skilled in the art).

Software monitor (MON) functions may be embedded by a security-oriented compiler into such a system. Although such software monitors increase the degree of self-checking, the underlying hardware remains TEC and thus, there always is a way around any and all MON functions realized in software. The present disclosure therefore includes an apparatus which is an ATE based on the ISC2 compact notation of FIGS. 1-5 that employs the static description of, e.g., a NAND gate(s) plus complete run-time traces of the (data elements) flowing through the system in {data processing paths} that depend on <conditions represented e.g. in if-then-else structures> of the software on the GPP hardware. From the hardware description and from the source code, optionally employing conventional MON software, the ATE may synthesize the compact notation of exactly how the existing system works in terms of (data things)/processed while flowing down\ {hardware-software paths} selected by <decision criteria of the hardware (e.g. interrupts) and software (e.g. values of control variables)>.

By analyzing the design documentation (e.g. hardware and source code) and by observing an existing system over time, the ISC2 ATE apparatus may generate a definitive description (DD) of the existing system that includes how its operating system, communications, and applications work and specifically how user data such as (Joe's salary) are processed. The methods for generating the DD are disclosed in FIGS. 1-5 and Table 1. In addition, operations 602 and 604 may include software of a forensic nature, techniques for generating the DD efficiently, and other implementation details that may be protected by copyright, trade secret, and other methods for protecting intellectual property (IP) and that therefore need not be disclosed in detail in this patent application. The above provides the detail necessary for one skilled in the art to understand how to make and use what is claimed without the need for “undue” experimentation.

The DD of an existing system of FIG. 6 may be hierarchical. A path of the DD that compactly notes the structure of an input output interrupt, for example, may include things such as (NAND gates), (clocks), and (registers) in the hardware, each of which exhibit [input] and [output] places by which their signals become available to an {interrupt service routine (ISR)}, to the {real time executive} and ultimately to {an application}, e.g. to a {listener function} for such a signal. Thus, the DD may include a {path from a device such as (a mouse) through the (mouse interface hardware) to the (mouse device driver) to a (mouse click) variable}. The path {from (the mouse) through the (mouse interface hardware)} may be compactly noted as a path within (the mouse interface board) that may include (a PCI [bus]) and (an 10 [register] assigned to the mouse) as well as (an interrupt level).

Once discovered by the ISC2 ATE, the {mouse-interrupt} path itself may be noted compactly as a (thing), a ({mouse-interrupt} path) that may be included to form a hierarchical expression, e.g., in other {paths} such as in {an applications listener} that listens for a (mouse-interrupt) so that the hardware-intensive path {mouse-interrupt} forms a lower level (abstract data thing) that may be reused in the DD at a higher level of abstraction and complexity such as in an {applications listener for the ({mouse-interrupt})}. Some {paths} may correspond in a one-to-one mapping between a software module and a {path} of a compact notation.

A software module in C-code, for example, is based on a “main” program with associated function subprograms. The compact notation for such a program may be via the compact notation {“main” [input (5 [‘type’ (int)])] . . . } or via the more verbose XML expression <Path name=“main”> through </Path> which is the XML tag notation for start and end of a path, noted compactly as {“main” . . . }. There are many such correspondences that may be defined and that may comprise trade secrets or copyright of the software of such an ATE apparatus that may further optimize the method and apparatus with respect to applications-specific criteria which may differ from domain (e.g. payroll) to domain (e.g. web services) and that may further obfuscate or otherwise protect a specific embodiment of the ATE (itself) from unauthorized use.

The DD for hardware (603) and software (605) in final form of FIG. 6, then consists of a comprehensive set of the (things), [places], {paths}, /actions\, and <causes> of the existing system, whether described statically in documentation or observed dynamically via the ISC2 ATE, optionally assisted by such embedded MON functions as may be helpful for forensic analysis of the existing system's structure and behavior.

FIG. 7 shows how to combine the DD of an existing system with a brief specification 703 in compact notation of an ISC2 system, such as ((self “Payroll”) (IPoverlays [1 (IPcells [1000 (PEs (1:1000)])]), which is a payroll system consisting of one IPoverlay that consists of 1000 IPcells each of which contains 1000 processing elements (PEs). The specification 703 may be a guide to the formation of a new system 705 consisting of new hardware 707 and hardware-dependent data 709. The definitive mapping 704 may map the specification the hardware-software paths of DD 603 (plus other related hardware information in compact notation to form DD701) onto the new hardware indicated in specification 703 so as to perform the payroll functions of the existing system based on its DD605 plus other related software information in compact notation that forms DD702.

For example, a definitive mapping 704 may generate the COP of FIG. 8 of the '835 application with its PEs and associated functions, e.g. of multiplying salary data times the hours worked per week to yield data for weekly pay. In such a case, the register set of the existing GPP defines the operations that were performed via the payroll software, e.g. the details of multiplication right down to the least significant bit so that the PEs of FIG. 8 of the '835 application realize exactly the payroll functions of the existing payroll system. However, the realization in multiple PEs that are self-checking and cross-checking provides for effective implementation of the existing application onto massively parallel hardware as well as to cross-checking of inputs, outputs, data and control flows according to the 835 application for improved secure computing and communications.

We claim:

1. A method comprising the steps of:
applying compact markup notation to a general recursive computing system including hardware and software components, the compact markup notation defining things, places, paths, actions and causes within at least one of the hardware and the software components of the general recursive computing system, to establish a set of data comprising a definitive description of a computing system in the compact markup notation; and
synthesizing a self-aware and self-monitoring primitive recursive computing system utilizing the definitive description in the compact markup notation.

2. A method comprising the steps of:
describing a general recursive computing system in a definitive description utilizing a compact markup notation including a set of elements comprising at least some of a (thing), a [place], a {path}, an /action\ and a <cause> to create the definitive description of the general recursive computing system; and
mapping the definitive description onto a self-aware and self-evaluating primitive recursive computing system comprising a collection of information processing cells each comprising at least one memory based transform processing element, the information processing cells organized into information processing overlays, performing at least one function defined by the definitive description within the self-aware and self-evaluating primitive recursive computing system.

3. The method of claim 2 wherein the set of elements is determined from a physical description of at least one hardware element of the general recursive computing system.

4. The method of claim 2 wherein the set of elements is determined from an observation of the functioning of at least one hardware element of the general recursive computing system.

5. The method of claim 2 wherein the set of elements is determined from a software description of at least one function of the general recursive computing system

6. The method of claim 2 wherein the definitive description is determined by an automated test engine.

7. The method of claim 6 wherein the definitive description is determined by utilizing a software monitor function to assist the automated test engine.

8. The method of claim 2 wherein the at least one memory based transform processing element comprises self-referential apparatus-dependent data; and the method further comprises:
utilizing the self-referential apparatus-dependent data to modulate self-awareness behavior of the primitive recursive computing system.

9. The method of claim 2 wherein the primitive recursive computing system further comprises a communications system.

10. The method of claim 8 wherein the primitive recursive system further comprises a communications system.

11. A system comprising:
a self-aware and self-monitoring primitive recursive computing system synthesized using a compact markup notation applied to a general recursive computing system, the general recursive computing system including hardware and software components, the compact markup notation defining things, places, paths, actions and causes within at least one of the hardware and software components of the general recursive computing system, and the compact markup notation establishing a set of data comprising a definitive description of the general recursive computing system in the compact markup notation, from which the definitive description of the primitive recursive computing system is synthesized.

12. A system comprising:
a self-aware and self-evaluating primitive recursive computing system embodying a mapping of a definitive description of a general recursive computing system on to the primitive recursive computing system and, utilizing a compact markup notation, the compact markup notation including a set of elements comprising at least some of a (thing), a [place], a {path}, an /action\ and a <cause>;
wherein the self-aware and self-evaluating primitive recursive computing system comprises a collection of information processing cells each comprising at least one memory based transform processing element, the information processing cells organized into information processing overlays, performing at least one function defined by the definitive description.

13. The system of claim 12 wherein the set of elements is determined from a physical description of at least one hardware element of the general recursive computing system.

14. The system of claim 12 wherein the set of elements is determined from an observation of the functioning of at least one hardware element of the general recursive computing system.

15. The system of claim 12 wherein the set of elements is determined from a software description of at least one function of the general recursive computing system.

16. The system of claim 12 wherein the definitive description is determined by an automated test engine.

17. The system of claim 16 wherein the definitive description is determined by utilizing a software monitor function to assist the automated test engine.

18. The system of claim 2 wherein the at least one memory based transform processing element comprises self-referential apparatus-dependent data; and
the self-referential apparatus-dependent data modulates a self-awareness behavior of the primitive recursive computing system.

19. The system of claim 12 wherein the primitive recursive computing system further comprises a communications system.

20. The method of claim 18 wherein the primitive recursive computing system further comprises a communications system.
